(19) United States
(12) Patent Application Publication
(10) Pub. No.: US 2019/0107937 A1
(43) Pub. Date: Apr. 11, 2019

(54) CONTROLLER, SHORTCUT ICON REGISTRATION METHOD, AND NON-TRANSITORY RECORDING MEDIUM STORING SHORTCUT ICON REGISTRATION PROGRAM

(71) Applicant: Konica Minolta, Inc., Tokyo (JP)

(72) Inventor: Mitsutaka Morita, Tokyo (JP)

(73) Assignee: Konica Minolta, Inc., Tokyo (JP)

(21) Appl. No.: 16/154,056

(22) Filed: Oct. 8, 2018

(30) Foreign Application Priority Data
Oct. 10, 2017 (JP) 2017-196497

(51) Int. Cl. G06F 3/0481; G06F 3/0482; H04N 1/00

(52) U.S. Cl. CPC G06F 3/04817; H04N 1/00424; G06F 3/0482

(57) ABSTRACT

A hardware processor of the controller displays, on a display, one of screens each handling at least one setting item for a certain kind of functions. The screen includes a setup area and an icon area showing shortcut icons for instructing to display one of the screens. The shortcut icons include at least one unregistered shortcut icon associated with no shortcut destination. In response to a selection of an unregistered shortcut icon in the icon area, the hardware processor displays a list of categories of setting items. In response to a selection of one of the categories, the hardware processor registers the selected category as being associated with the selected shortcut icon, and displays information indicating the selected category together with the selected shortcut icon in the icon area.

### CROSS-REFERENCE TO RELATED APPLICATIONS

Japanese Patent Application No. 2017-196497 filed on Oct. 10, 2017, including description, claims, drawings, and abstract, the entire disclosure of which is incorporated herein by reference in its entirety.

### TECHNICAL FIELD

The present invention is directed to controllers, shortcut icon registration methods and non-transitory recording media each storing a computer-readable program for registering a shortcut icon.

### BACKGROUND

Many apparatuses having various kinds of functions are configured to display screens each of which handles at least one setting item for one of the various kinds of functions so that an operator can move to an appropriate screen and configure the at least one setting item on the screen, and are configured to activate the functions according to the configured settings. In such apparatuses, shortcut icons each for giving instructions to display a screen that handles at least one setting item for a certain kind of functions, are available so as to make operator's configuration operations for the various kinds of the functions easier.

As a method for registering such a shortcut icon, there is known a method using a setup screen for shortcut icon registration. For example, Japanese Unexamined Patent Publication (JP-A) No. 2004-132740 discloses the following electronic device. The device includes a display unit, a storage unit storing programs that activate various kinds of functions, and a configuration table for specifying multiple command icons that give instructions to start the respective programs. The device further includes a display instruction key that gives instructions to the display unit to display the command icons specified in the configuration table. The device further includes a display controller that causes the display unit to display multiple command icons specified in the setup table, in response to receiving the instructions given from the display instruction key, and that causes the display unit to hide the command icons after a lapse of a predetermined time period from the time when the command icons are displayed. In the device, in response to receiving instructions to setup a shortcut icon, the display controller causes the display unit to display a shortcut setup screen so as to allow an operator to setup a shortcut icon on the screen.

In this technique, an operator needs to move to the shortcut setup screen at each time when registering a shortcut icon, which takes operator's time and effort to register a shortcut icon. In view of that, JP-A No. 2012-123477 discloses a method of registering an icon for use in shortcut functions to, in response to operator's operations on an icon in a shortcut registration area, reproduce a device operation state recorded in association with the icon. In the method, in response to operator's operations on a blank icon for which no device operation state is recorded, a device operation state at the time of the operator's operations, is recorded in association with the operated icon. In response to operator's operations on a registered icon for which a device operation state has been recorded, the device operation state recorded in association with the icon is reproduced.

However, even if using the method of registering a shortcut icon on the basis of the screen state (the device operation state) at the time when an operator selected a blank icon, an operator needs to move to a screen the state of which the operator wants to register in association with a shortcut icon, each time when registering a shortcut icon. It still takes operator's time and effort to register a shortcut icon.

### SUMMARY

One or more embodiments of the present invention are directed to controllers, shortcut icon registration methods and non-transitory recording media each storing a computer-readable program for registering a shortcut icon, which allow an operator to perform shortcut icon registration easily without causing the operator to move to a screen that the operator wants to associate with the shortcut icon. For example, one or more embodiments are directed to controllers configured to display screens that handle setting items for various kinds of functions so as to allow an operator to move to appropriate screens and configure setting items for the functions on the screens, shortcut icon registration methods for registering a shortcut icon being an icon for instructing to display a screen which handles at least one setting item for a certain kind of functions, and non-transitory recording media each storing a computer-readable shortcut icon registration program for controlling registration of shortcut icons.

A controller reflecting one or more embodiments of the present invention comprises a display and a hardware processor. The display displays a plurality of screens, each of which handles at least one setting item for one of a plural kinds of functions, so as to allow an operator to move to one of the plurality of screens and configure the at least one setting item on the one of the plurality of screens. The hardware processor performs the following operations. The operations include, displaying on the display one of the plurality of screens. The one of the plurality of screens includes a setup area showing at least one setting item in a certain category for one of the plural kinds of functions so as to allow an operator to configure the at least one setting item, and an icon area showing shortcut icons for instructing the display to display one of the plurality of screens, so as to allow an operator to select one of the shortcut icons, wherein the shortcut icons include at least one registered shortcut icon associated with a category of setting items for one of the plural kinds of functions and at least one unregistered shortcut icon not associated with a category of setting items for one of the plural kinds of functions. The operations further include, in response to an operator's selection of an unregistered shortcut icon in the icon area, displaying, on the one of the plurality of screens displayed on the display, a list of categories of setting items that can be registered with being associated with the unregistered shortcut icon. The operations further include, in response to an operator's selection of one of the categories of setting items from the list, registering the one of the categories of setting items with being associated with the unregistered shortcut icon, and displaying, in the icon area, information that makes an operator recognize the one of the categories of setting items, together with the unregistered shortcut icon.

A method reflecting one or more embodiments of the present invention is a method of registering a shortcut icon in an apparatus. The apparatus is configured to display, on a display of the apparatus, a plurality of screens, each of which handles at least one setting item for one of a plural kinds of functions, so as to allow an operator to move to one of the plurality of screens and configure the at least one setting item on the one of the plurality of screens, wherein the shortcut icon is an icon for instructing the display to display one of the plurality of screens. The method comprises displaying on the display one of the plurality of screens. The one of the plurality of screens includes a setup area showing at least one setting item in a certain category for one of the plural kinds of functions so as to allow an operator to configure the at least one setting item, and an icon area showing shortcut icons for instructing the display to display one of the plurality of screens, so as to allow an operator to select one of the shortcut icons, wherein the shortcut icons include at least one registered shortcut icon associated with a category of setting items for one of the plural kinds of functions and at least one unregistered shortcut icon not associated with a category of setting items for one of the plural kinds of functions. The method further comprises, in response to an operator's selection of an unregistered shortcut icon in the icon area, displaying, on the one of the plurality of screens displayed on the display, a list of categories of setting items that can be registered with being associated with the unregistered shortcut icon. The method further comprises, in response to an operator's selection of one of the categories of setting items from the list, registering the one of the categories of setting items with being associated with the unregistered shortcut icon, and displaying, in the icon area, information that makes an operator recognize the one of the categories of setting items, together with the unregistered shortcut icon.

A non-transitory recording medium reflecting one or more embodiments of the present invention stores a computer-readable program for registering a shortcut icon in an apparatus. The apparatus is configured to display, on a display of the apparatus, a plurality of screens, each of which handles at least one setting item for one of a plural kinds of functions, so as to allow an operator to move to one of the plurality of screens and configure the at least one setting item on the one of the plurality of screens, wherein the shortcut icon is an icon for instructing the display to display one of the plurality of screens. The program comprises instructions which, when executed by a hardware processor of the apparatus, cause the hardware processor to perform the following operations. The operations comprise, displaying, on the display, one of the plurality of screens. The one of the plurality of screens includes a setup area showing at least one setting item in a certain category for one of the plural kinds of functions so as to allow an operator to configure the at least one setting item, and an icon area showing shortcut icons for instructing the display to display one of the plurality of screens, so as to allow an operator to select one of the shortcut icons, wherein the shortcut icons include at least one registered shortcut icon associated with a category of setting items for one of the plural kinds of functions and at least one unregistered shortcut icon not associated with a category of setting items for one of the plural kinds of functions. The operations further comprise, in response to an operator's selection of an unregistered shortcut icon in the icon area, displaying, on the one of the plurality of screens displayed on the display, a list of categories of setting items that can be registered with being associated with the unregistered shortcut icon. The operations further comprise, in response to an operator's selection of one of the categories of setting items from the list, registering the one of the categories of setting items with being associated with the unregistered shortcut icon, and displaying, in the icon area, information that makes an operator recognize the one of the categories of setting items, together with the unregistered shortcut icon.

### BRIEF DESCRIPTION OF DRAWINGS

The advantages and features provided by one or more embodiments of the invention will become more fully understood from the detailed description given herein below and the appended drawings which are given by way of illustration only, and thus are not intended as a definition of the limits of the present invention, wherein:

FIG. 1 is a schematic diagram illustrating an example of the constitution of a printing system according to one or more embodiments;

FIG. 2 is a schematic diagram illustrating another example of the constitution of the printing system according to one or more embodiments;

FIGS. 3A and 3B are block diagrams illustrating an example of the constitution of a client terminal according to one or more embodiments;

FIGS. 4A and 4B are block diagrams illustrating an example of the constitution of an image forming apparatus according to one or more embodiments;

FIG. 5 is a flowchart illustrating an example of operations of the image forming apparatus according to one or more embodiments;

FIG. 6 is a diagram illustrating an example of a screen displayed on the image forming apparatus according to one or more embodiments;

FIG. 7 is a diagram illustrating another example of a screen (on which one of setting categories is being selected) displayed on the image forming apparatus according to one or more embodiments;

FIG. 8 is a diagram illustrating an example of a copy screen (on which shortcut icon registration has been performed) displayed on the image forming apparatus according to one or more embodiments;

FIG. 9 is a flowchart illustrating an example of operations of the image forming apparatus according to one or more embodiments;

FIG. 10 is a diagram illustrating an example of a copy screen (on which a blank icon is being selected) displayed on the image forming apparatus according to one or more embodiments;

FIG. 11 is a diagram illustrating another example of a copy screen (on which a list of setting categories is being displayed) displayed on the image forming apparatus according to one or more embodiments;

FIG. 12 is a diagram illustrating another example of a copy screen (on which one of setting categories is being selected) displayed on the image forming apparatus according to one or more embodiments;

FIG. 13 is a diagram illustrating another example of a copy screen (on which shortcut icon registration has been performed) displayed on the image forming apparatus according to one or more embodiments;

FIG. 14 is a flowchart illustrating an example of operations of the image forming apparatus according to one or more embodiments;

FIG. 15 is a flowchart illustrating another example of operations of the image forming apparatus according to one or more embodiments;

FIG. 16 is a diagram illustrating an example of a layout of shortcut icons according to one or more embodiments;

FIG. 17 is a table of icons, kinds of screen and setting categories which are associated with each other (given after shortcut icon registration on the copy screen) according to one or more embodiments;

FIG. 18 is a diagram illustrating an example of a scan screen displayed on the image forming apparatus according to one or more embodiments;

FIG. 19 is a diagram illustrating another example of a scan screen (on which a blank icon is being selected) displayed on the image forming apparatus according to one or more embodiments;

FIG. 20 is a diagram illustrating another example of a scan screen (on which one of setting categories is being selected) displayed on the image forming apparatus according to one or more embodiments;

FIG. 21 is a diagram illustrating another example of a scan screen (on which shortcut icon registration has been performed) displayed on the image forming apparatus according to one or more embodiments;

FIG. 22 is a table of icons, kinds of screen and setting categories which are associated with each other (given after shortcut icon registration on the scan screen) according to one or more embodiments;

FIG. 23 is a diagram illustrating an example of a scan screen (on which a blank icon is being selected) displayed on the image forming apparatus according to one or more embodiments; and

FIG. 24 is a diagram illustrating another example of a scan screen (on which a list of setting categories is being displayed) displayed on the image forming apparatus according to one or more embodiments.

### DETAILED DESCRIPTION

Hereinafter, one or more embodiments of the present invention will be described with reference to the drawings. However, the scope of the invention is not limited to the illustrated embodiments.

There is a method of registering a shortcut icon by using a setup screen for a shortcut icon registration. In this method, an operator needs to move to the shortcut setup screen each time when registering a shortcut icon, which takes operator's time and effort. As another method of registering a shortcut icon, there is known a method of registering the screen state (the device operation state) at the time when an operator selected a blank shortcut icon, in association with the selected blank shortcut icon. However, even if using this method, an operator still needs to move to a screen the state of which the operator wants to register in association with a shortcut icon, each time when registering a shortcut icon. It also takes operator's time and effort to register a shortcut icon.

In special, printing devices, like MFPs, have various kinds of functions (relating to image formation), such as copy functions, scan functions and facsimile functions. For activating various kinds of functions, each device provides a number of screens that handle setting items for the various kinds of functions, and it is necessary for an operator to configure a large number of setting items for various kinds of functions, on the screens. It complicates operator's operations to move to a desired screen, and takes long time before the operator reaches a screen that the operator wants to register in association with a shortcut icon.

In view of that, there are provided a controller and control operations, which allow an operator to perform shortcut icon registration by intuitive and easy operations, as one or more embodiments of the present invention. In concrete terms, the controller includes a hardware processor and a display configured to display a plurality of screens, each of which handles at least one setting item for one of a plural kinds of functions, so as to allow an operator to move to one of the plurality of screens and configure at least one setting item on the one of the plurality of screens. The hardware processor is configured to perform a shortcut icon registration, where the shortcut icon is an icon for instructing the display to display one of the plurality of screens, that handles at least one setting item for one of a plural kinds of functions. That is, the hardware processor causes the display to display one of the plurality of screens including a setup area and an icon area. The setup area shows at least one setting item in a certain category for one of the plural kinds of functions so as to allow an operator to configure the at least one setting item. The icon area shows shortcut icons for instructing the display to display one of the plurality of screens, so as to allow an operator to select one of the shortcut icons, wherein the shortcut icons include at least one registered shortcut icon being at least one shortcut icon associated with a category of setting items for one of the plural kinds of functions and at least one unregistered shortcut icon being at least one shortcut icon not associated with a category of setting items for one of the plural kinds of functions. In response to an operator's selection of an unregistered shortcut icon in the icon area, the hardware processor displays, on the one of the plurality of screens currently displayed on the display, a list of categories of setting items that can be registered with being associated with the selected unregistered shortcut icon. In response to an operator's selection of one of the categories of setting items from the list, the hardware processor registers the one of the categories of setting items selected from the list, with being associated with the selected unregistered shortcut icon, and displays, in the icon area, information that makes an operator recognize the selected category of setting items, together with the selected unregistered shortcut icon.

On displaying the list, the hardware processor may change categories of setting items that appear in the list, in accordance with a kind of a specific screen which is one of the plurality of screens displayed on the display at a time when the operator selected the unregistered shortcut icon in the icon area. In this process, the hardware processor may extract a part of the categories of setting items that can be registered with being associated with the selected unregistered shortcut icon, on the basis of the kind of the specific screen, and display a list of the part of the categories of setting items. On displaying the list, the hardware processor may display a list of at least one category of setting items that corresponds to the specific screen and can be registered with being associated with the selected unregistered shortcut icon and at least one category of setting items that can be registered with being associated with the selected unregistered shortcut icon regardless of the specific screen. On displaying the list, the hardware processor may display, in the list, the categories of setting items that relate to a category of setting items associated with another registered shortcut icon placed close to the selected unregistered shortcut icon in the icon area. On registering the selected category of setting items, the hardware processor may register the selected category of setting items and the kind of the specific screen (which is one of the plurality of screens displayed on the display at a time when the operator selected the unregistered shortcut icon in the icon area), with being associated with the selected unregistered shortcut icon. When displaying, on the display, one of the plurality of screens corresponding to a certain kind of the functions, after the registration, the hardware processor may change the shortcut icons that appear in the icon area, in accordance with the one of the plurality of screens corresponding to the certain kind of the functions. In this process, on displaying a shortcut icon associated with a category of setting items for a certain kind of the functions, in the icon area of one of the plurality of screens corresponding to the certain kind of the functions, the hardware processor may display a registered shortcut icon associated with the category of setting items, in the icon area for the shortcut icon; and on displaying the shortcut icon in the icon area of one of the plurality of screens corresponding to another kind of the functions, the hardware processor may display an unregistered shortcut icon not associated with a category of setting items, in the icon area for the shortcut icon.

As described above, the hardware processor performs the operations to display on the display an icon area that shows at least one registered shortcut icon and at least one unregistered shortcut icon so as to allow an operator to select one of the shortcut icons; and in response to an operator's selection of an unregistered shortcut icon in the icon area, display on the display a list of categories of setting items that can be registered with being associated with the selected unregistered shortcut icon. Such operations allow an operator to perform shortcut icon registration easily with less time and effort, because in the operations, there are no need to move to a setup screen for performing shortcut icon registration at each time when the operator registers a shortcut icon and no need to move to a screen that the operator wants to register for a shortcut icon.

Hereinafter, descriptions are given of an apparatus configured to register a shortcut icon for instructing to display a screen that handles at least one setting item for a certain kind of functions, under the assumption that the functions for use in the shortcut icon registration relate to a field of image formation (such as printing), which include plural kinds of basic functions and a number of advanced functions corresponding to each kind of the basic functions, and cause an operator to go around a number of screens in order to configure setting items for a certain kind of functions. In the following descriptions, a shortcut icon associated with a shortcut destination or a category of setting items for a certain kind of functions is simply referred to as an icon or a shortcut icon, and an unregistered shortcut icon being a shortcut icon not associated with a shortcut destination or a category of setting items for a certain kind of functions is referred to as a blank icon.

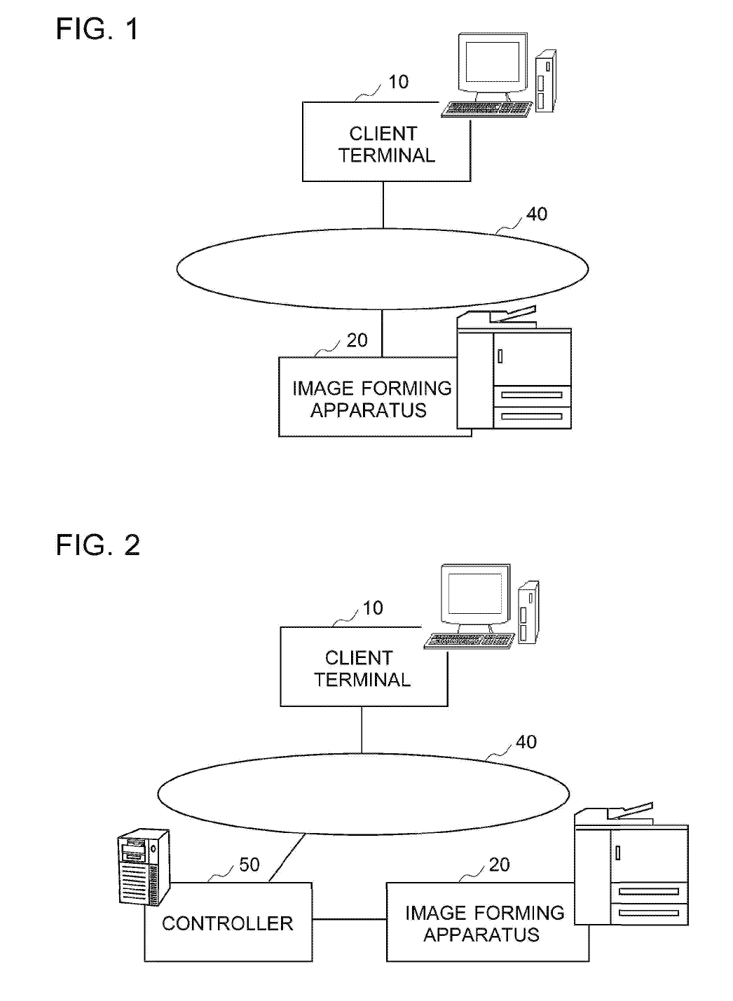

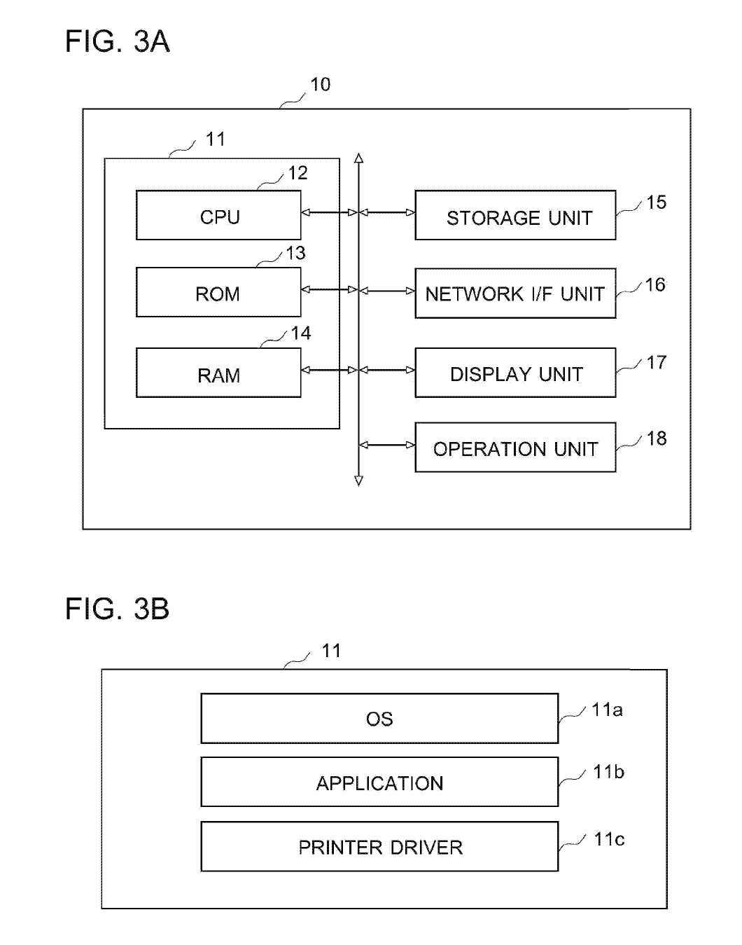

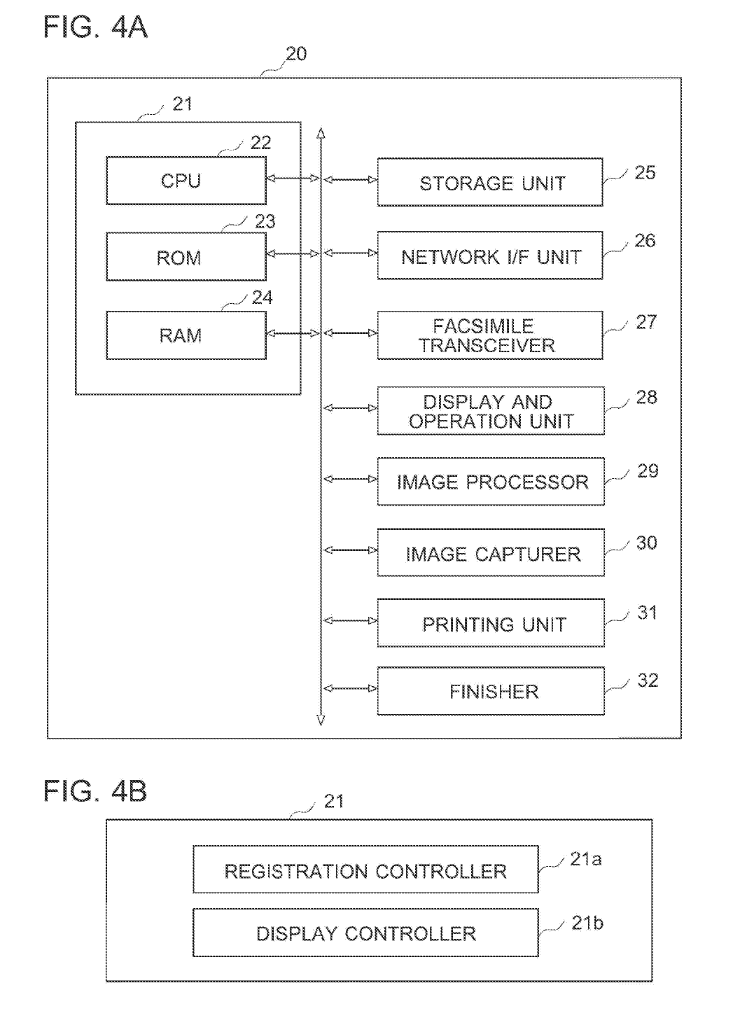

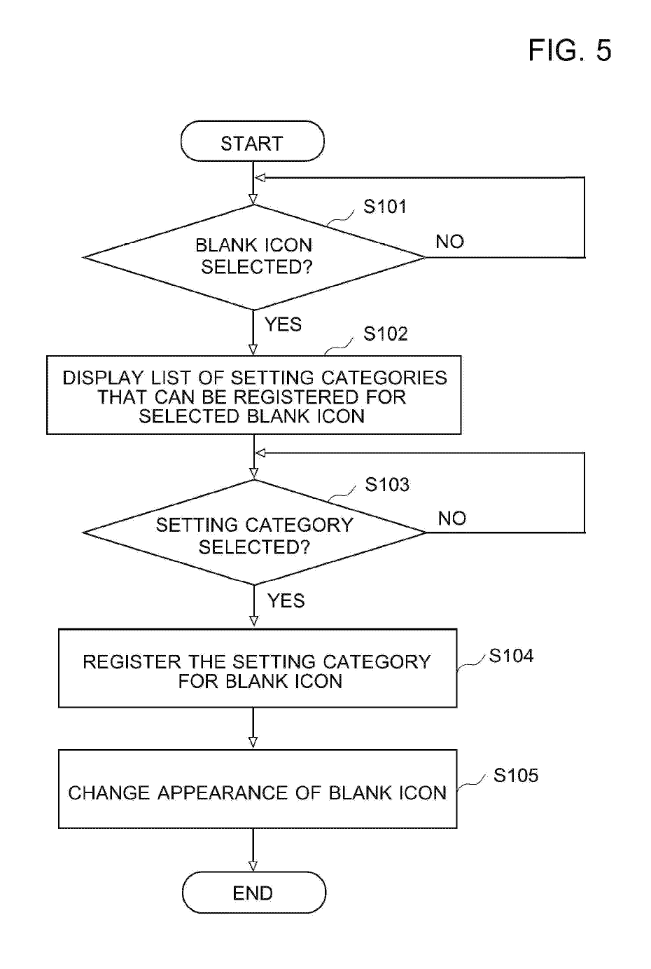

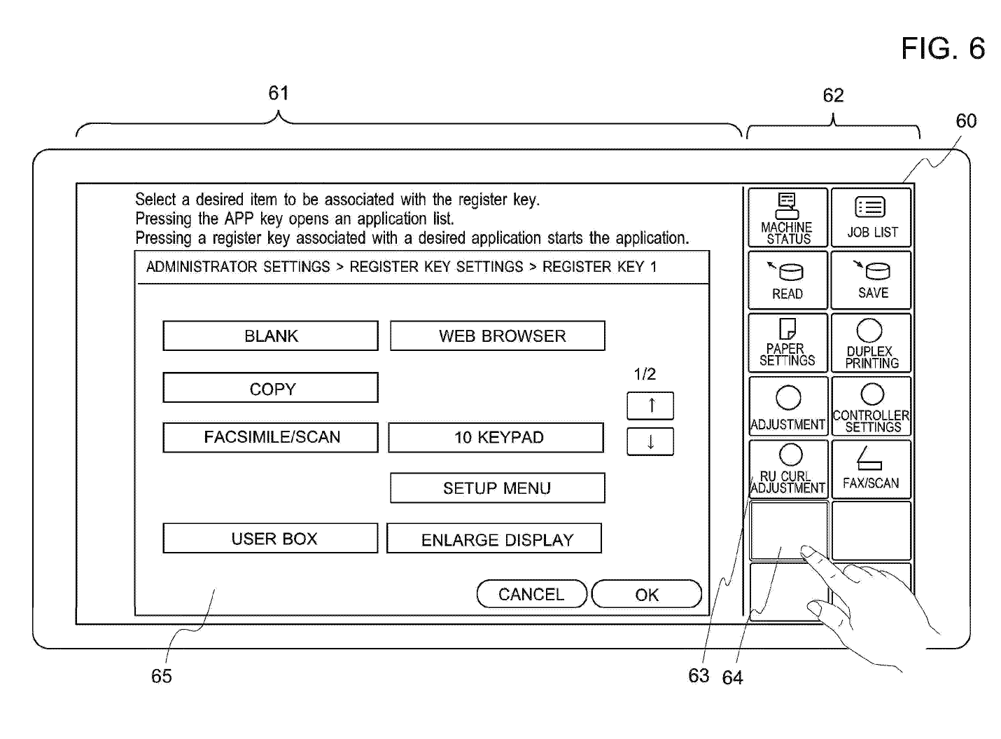

Below, a description is given of a controller, a shortcut icon registration method and a non-transitory recording medium storing a shortcut icon registration program according to one or more embodiments, with reference to FIG. 1 through FIG. 8. FIG. 1 and FIG. 2 are schematic diagrams illustrating examples of the constitution of a printing system according to one or more embodiments. FIGS. 3A and 3B are block diagrams illustrating an example of the constitution of a client terminal. FIGS. 4A and 4B are block diagrams illustrating an example of the constitution of an image forming apparatus. FIG. 5 is a flowchart illustrating an example of operations of the image forming apparatus according to one or more embodiments. FIGS. 6 to 8 are diagrams illustrating examples of a screen displayed on the image forming apparatus according to one or more embodiments.

As illustrated in FIG. 1, a printing system according to one or more embodiments includes client terminal 10 and image forming apparatus 20 which are located in an intranet so that they can be communicatively connected to each other via communication network 40. Although the printing system illustrated in FIG. 1 includes client terminal 10 and image forming apparatus 20, the printing system may further include controller 50 for controlling image forming apparatus 20 as illustrated in FIG. 2. As an example of the communication network 40, an Ethernet network may be used. Data transfer from controller 50 to image forming apparatus 20 may be performed through a system conforming to the standards, such as IEEE 1394, parallel or the like, other than the Ethernet. Hereinafter, a description of each apparatus is given on the assumption of the structure of the printing system illustrated in FIG. 1.

### Client Terminal:

Client terminal 10 is a computing device like a personal computer and includes, as illustrated in FIG. 3A, built-in controller 11 and storage unit 15, network interface (UF) unit 16, display unit 17 and operation unit 18.

Built-in controller 11 includes a CPU (Central Processing Unit) 12 as a hardware processor, and memories including ROM (Read Only Memory) 13 and a RAM (Random Access Memory) 14, where these components are connected to each other through a bus. CPU 12 reads out programs stored in the ROM 13 or the storage unit 15, loads the programs onto RAM 14, and executes the programs, thereby controlling operations of the components of client terminal 10.

Built-in controller 11 (CPU 12) is further configured to execute, as illustrated in FIG. 3B, OS (Operating System) 11a, applications 11b and printer driver 11c and other programs.

Examples of OS 11a include Windows, macOS and Android, where Windows is a registered trademark of Microsoft Corporation in the United States and/or other countries, macOS is a trademark of Apple Inc. in the U.S. and other countries, and Android is a trademark of Google Inc. in the United States and/or other countries. OS 11a manages applications 11b and printer driver 11c in the client terminal 10 so as to function and run the programs.

Examples of applications 11b include word processing, spreadsheet, and image processing programs. For sending print instructions, application 11b invokes printer driver 11c and transfers original data created by the application 11b to printer driver 11c.

Printer driver 11c is a program that converts original data created by application 11b into a print job written in a language that image forming apparatus 20 can interpret, where examples of the print job include PDL (Page Description Language) data written in page description languages, such as PJL (Printer Job Language), PS (PostScript) and PCL (Printer Control Language); and PDF (Portable Document Format) data. Printer driver 11c causes display unit 17 to display a print setup screen for instructing image forming apparatus 20 to perform print processing by using the functions of image forming apparatus 20. Alternatively, printer driver 11c may be configured to realize the functions of the built-in controller (registration controller and display controller) of image forming apparatus 20, which will be described later, so as to cause CPU 12 to perform operations to register a shortcut icon, when being executed by CPU 12.

Storage unit 15 is a non-transitory computer-readable recording medium including a HDD (Hard Disk Drive) and/or a SSD (Solid State Drive), which stores programs which when being executed causes CPU 12 to control the components of client terminal 10, data necessary for execution of the programs, original data, a print job and other data.

Network I/F unit 16 includes a NIC (Network Interface Card) and/or a modem. The network I/F unit 16 communicatively connects client terminal 10 to communication network 40, so as to send a print job to image forming apparatus 20.

Display unit 17 includes a display like a LCD (liquid crystal display) or an OEL (organic electroluminescence) display, so as to display an original creation screen of application 11b, a print setup screen of printer driver 11c, and others. Operation unit 18 includes input devices, such as a mouse, a keyboard and a touch sensor combined with display unit 17 as one body, which allow an operator to perform various operations to create an original and to configure printing conditions.

### Image Forming Apparatus:

Image forming apparatus 20 is a printing device a MFP (multi-functional peripheral), and includes, as illustrated in FIG. 4A, built-in controller 21, storage unit 25, network interface (UF) unit 26, facsimile transceiver 27, display and operation unit 28, image processor 29, image capturer 30, printing unit 31 and finisher 32.

Built-in controller 21 includes CPU 22 as a hardware processor, and memories including ROM 23 and RAM 24, where these components are connected to each other through a bus. CPU 22 reads out programs stored in the ROM 23 or the storage unit 25, loads the programs onto RAM 24, and executes the programs, thereby controlling operations of the components of image forming apparatus 20.

Built-in controller 21 serves as a controller which causes display and operation unit 28 to display one of multiple screens each of which handles at least one setting item for a kind of functions (for example, functions of image forming apparatus 20) so that an operator can go around the screens and configure setting items for various kinds of the functions on the screens. In concrete terms, built-in controller 21 is configured to, as illustrated in FIG. 4B, work as registration controller 21a and display controller 21b.

Registration controller 21a is configured to perform shortcut icon registration where a shortcut icon is an icon for instructing to display and operation unit 28 to display a screen that handles at least one setting item for a certain kind of the functions. In concrete terms, registration controller 21a is configured to perform the following operations. Registration controller 21a judges a selection of one of categories of setting items in a setting category list, which is a list of categories of setting items that can be registered with being associated with a blank icon, on the basis of signals output from display and operation unit 28. On judging that one of the categories of setting items has been selected from the list, registration controller 21a performs shortcut icon registration by associating an unregistered shortcut icon, which is a shortcut icon not associated with a category of setting items (blank icon), selected from shortcut icons shown in an icon area of a screen, with the category selected from the list of categories of setting items that can be registered with being associated with the blank icon, and by recording information about the association (for example, an association table) into storage unit 25.

Display controller 21b is configured to cause display and operation unit 28 to display various screens (such as a menu screen, a copy screen and a scan screen) each includes a setup area which shows at least one setting item in a certain category for one of the plural kinds of the functions so as to allow an operator to configure the at least one setting item, and an icon area which shows shortcut icons so as to allow an operator to select one of the shortcut icons. The shortcut icons are icons for instructing display and operation unit 28 to display one of the screens, and include at least one registered shortcut icon associated with a category of setting items for one of the plural kinds of functions and at least one unregistered shortcut icon (blank icon) not associated with a category of setting items for one of the plural kinds of functions. Display controller 21b is further configured to judge a selection of a blank icon in the icon area in the currently displayed screen, on the basis of signals output from display and operation unit 28, and on judging that a blank icon in the icon area has been selected, display on the screen a list of categories of setting items (hereinafter, referred to as setting categories) that can be registered with being associated with the selected blank icon. Display controller 21b is further configured to display information (text or image) which makes an operator recognize the setting category selected from the list, together with the selected blank icon in the icon area of the screen currently displayed.

Herein, the above-mentioned registration controller 21a and display controller 21b may be constituted as hardware devices. Alternatively, the above-mentioned registration controller 21a and display controller 21b may be provided by a shortcut icon registration program which causes built-in controller 21 to function as these sections when being executed by CPU 22. That is, built-in controller 21 may be configured to serve as the registration controller 21a and display controller 21b, when CPU 22 executes the shortcut icon registration program.

Storage unit 25 is a non-transitory computer-readable recording medium including a HDD and/or a SSD. Storage unit 25 stores programs which, when being executed, cause CPU 22 to control the components of image forming apparatus 20; data necessary for execution of the programs, a print job obtained from client terminal 10, an association table for associating icons, kinds of screen and setting categories with each other, and other data.

Network I/F unit 26 includes a NIC and/or a modem. The network I/F unit 26 communicatively connects image forming apparatus 20 to communication network 40, so as to receive a print job from client terminal 10.

Facsimile transceiver 27 is configured to handle facsimile communications with other facsimile machines through PSNT (public switched telephone network) in accordance with the procedures for facsimile transmission composed of five phases of phases A to E stipulated in ITU-T (International Telecommunication Union-Telecommunication) recommendation T.30.

Display and operation unit 28 is configured to display various screens relating to functions of image forming apparatus 20 and allow an operator to perform, on the screens, various kinds of operations relating to the functions of image forming apparatus 20. Examples of the display and operation unit 28 include a touch screen in which a pressure-sensitive or capacitive operation unit (a touch sensor) composed of lattice-shaped transparent electrodes is arranged on a display like a LCD or OEL display. In one or more embodiments, the display and the operation unit combined into one body are used as the display and operation unit 28, but the display and the operation unit may be separated bodies.

Image processor 29 includes a RIP (raster image processor) and is configured to parse a print job to create intermediate data and then perform rendering on the intermediate data to create raster data, where the series of these processes is referred to as “rasterization”.

Image capturer (scanner) 30 is an optical component that scans an original placed on a platen glass and captures image data of the original in an optical manner. Image capturer (scanner) 30 includes a light source to be used for scanning an original, an image sensor like a CCD (charge coupled device) for receiving light reflected by the original and converting the light into electric signals, and an AD converter for making an AD conversion from electric signals into digital signals.

Printing unit (print engine) 31 includes components necessary for image formation using image forming processes based on electrophotograpic recording or electrostatic recording, which are a charging unit, a photoreceptor drum, an exposure unit, a transfer roller, a transfer belt and a fixing unit. In concrete terms, in image forming processes, the exposure unit irradiates the photoreceptor drum, which was charged by the charging unit, with a laser beam in accordance with image data, to form a latent image to be printed, on the photoreceptor drum. The developing unit then develops the latent image by adhering charged toner onto the photoreceptor drum. The developed toner image is transferred onto a sheet of paper by using the transfer roller for first transfer processing and the transfer belt for second transfer processing, and is fixed onto the sheet by the fixing unit.

Finisher 32 is a device that performs finishing requested by an operator, on printed sheets conveyed from printing unit 31 in accordance with instructions given by built-in controller 21, where examples of the finishing includes punching, stapling, folding, cutting, binding and glue binding.

It should be noted that FIG. 1 to FIG. 4B illustrate the printing system according to one or more embodiments for illustrative purpose only, and the constitution and operations of each apparatus in the printing system may be modified appropriately. For example, facsimile transceiver 27 and finisher 32 of image forming apparatus 20 illustrated in FIGS. 4A and 4B may be omitted. In the above description, image forming apparatus 20 is configured to register a category of setting items for a certain kind of functions of image forming apparatus 20 with being associated with a shortcut icon, in response to operator's operations on a screen displayed on display and operation unit 28 of image forming apparatus 20. Alternatively, a category of setting items for a certain kind of the functions of image forming apparatus 20 may be registered with a shortcut icon, in response to operator's operations on a print setup screen of printer driver 11c executed in client terminal 10 or a setup screen displayed on a display of controller 50. In this case, built-in controller 11 of client terminal 10 or a built-in controller of controller 50 may be configured to work as the register controller and the display controller (in other words, CPU 12 of client terminal 10 or a CPU in the built-in controller of controller 50 may be configured to execute the shortcut icon registration program).

Hereinafter, a description is given of basic operations of image forming apparatus 20 with reference to examples of screens displayed on display and operation unit 28 of image forming apparatus 20. CPU 22 reads out the shortcut icon registration program stored in ROM 23 or storage unit 25, loads the program onto RAM 24, and executes the program, thereby executing the steps of the flowcharts illustrated in FIG. 5.

As illustrated in FIG. 5, built-in controller 21 (display controller 21b) judges a selection of one of at least one blank icon that appears in an icon area of the screen displayed on operation and display unit 28 is selected, on the basis of signals output from operation and display unit 28 (Step S101). On judging that a blank icon in the icon area has been selected (YES in Step S101), built-in controller 21 (display controller 21b) causes operation and display unit 28 to display a list of setting categories that can be registered for the selected blank icon (Step S102).

FIG. 6 illustrates an example of screen 60 (for example, a menu screen) displayed on operation and display unit 28 of image forming apparatus 20. The screen 60 includes setup area 61 and icon area 62. The setup area 61 shows at least one setting item for a certain kind of the functions of image forming apparatus 20 so as to allow an operator to configure the at least one setting item on the screen. The icon area 62 shows shortcut icons including at least one blank icon 64 additionally to at least one registered shortcut icon 63. In FIG. 6, icon area 62 shows a matrix of ten registered shortcut icons 63 (with 5 rows and 2 columns) which are shortcut icons each presenting text and/or image, and a matrix of four blank icons 64 (with 2 rows and 2 columns) which are shortcut icons each presenting no text and no image. In response to an operator's selection (a tap or touch action if the operation and display unit 28 is a touch screen) of one of blank icons 64 in the screen of FIG. 6, built-in controller 21 (display controller 21b) displays list screen 65 showing a list of setting categories that can be registered with being associated with the blank icon 64, on screen 60 (in setup area 61 in this case). The constructions of setup area 61 and icon area 62 are not limited to those illustrated in FIG. 6. The number of shortcut icons and the shape of shortcut icons shown in icon area 62 are not limited to those illustrated in FIG. 6, an arbitrary number of shortcut icons and an arbitrary shape of shortcut icons may be shown in icon area 62 as far as at least one blank icon 64 appears in icon area 62.

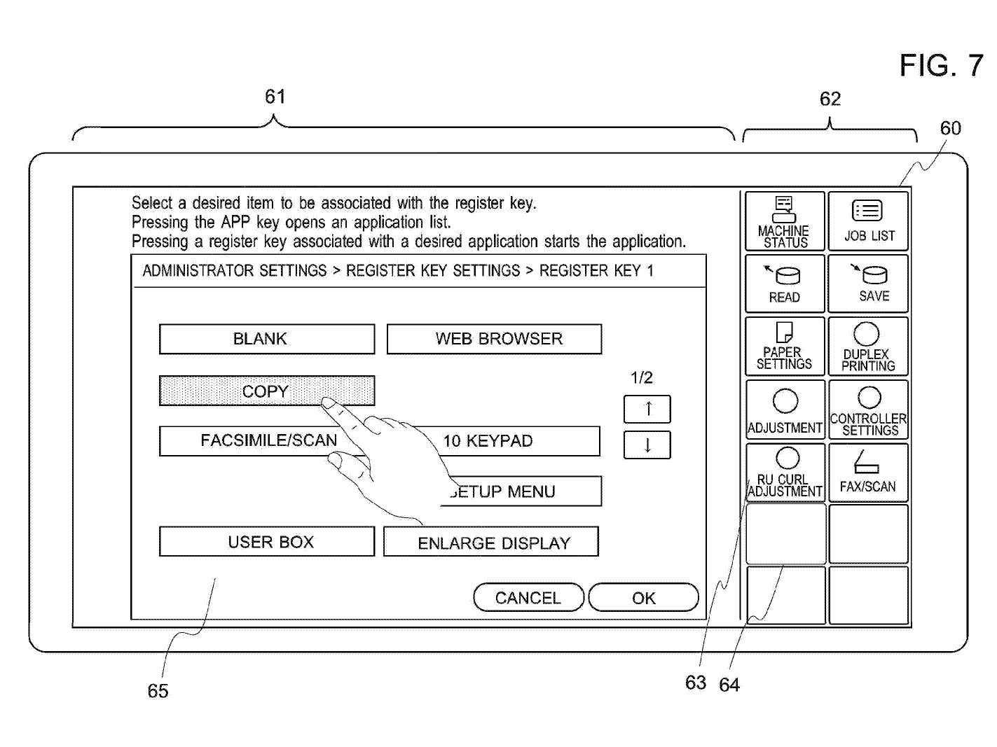

Next, built-in controller 21 (registration controller 21a) judges a selection of one of setting categories in the list is selected, on the basis of signals output from operation and display unit 28 (Step S103). On judging that a setting category has been selected from the list (YES in Step S103), built-in controller 21 (registration controller 21a) registers the selected setting category for the blank icon 64 (Step S104). For example, in response to an operator's selection of a desired setting category (in FIG. 6, “COPY”) from list screen 65 as illustrated in FIG. 7, built-in controller 21 (registration controller 21a) registers the setting category selected from list screen 65 with being associated with the selected blank icon 64.

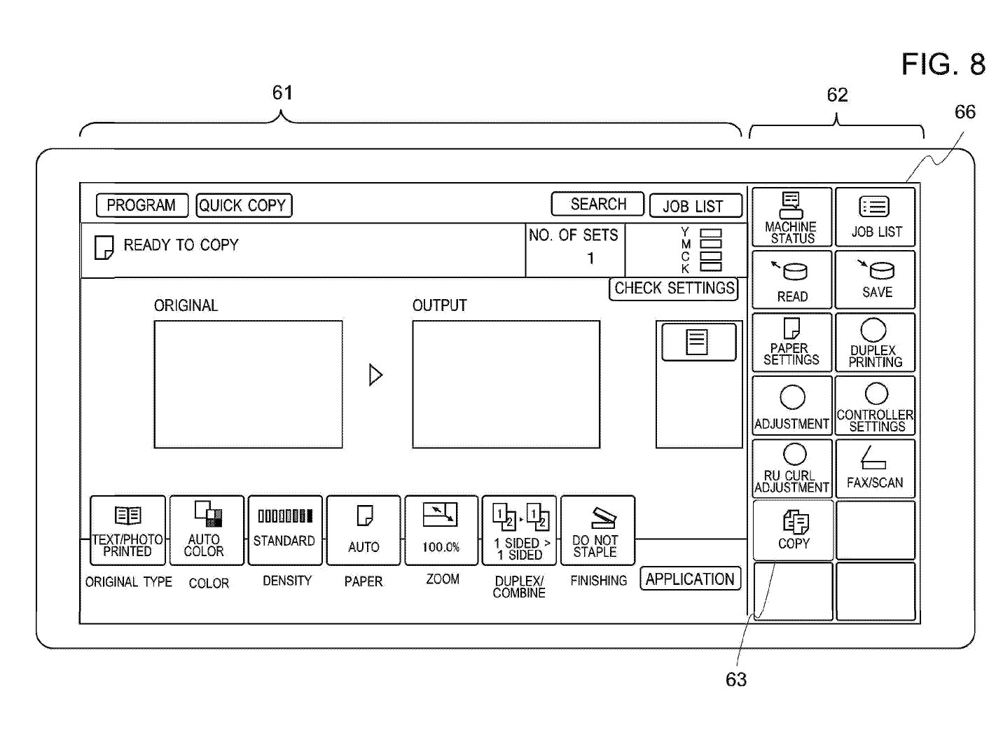

Built-in controller 21 (display controller 21b) then changes the appearance of the blank icon in icon area 62 to that corresponding to the registered setting category (Step S105). For example, as illustrated in FIG. 8, built-in controller 21 (display controller 21b) adds information (a text string “COPY” in the case of FIG. 8) that indicates the setting category selected from list screen 65, to the blank icon 64, and displays them together as registered icon 63 in icon area 62.

Accordingly, in one or more embodiments, built-in controller 21 causes operation and display unit 28 to display at least one blank icon 64 additionally to at least one registered shortcut icon 63 in icon area 62 of the currently displayed screen 60 so that an operator can select one of the icons, and in response to an operator's selection of one of the at least one blank icon 64 in icon area 62, displays a list of setting categories that can be registered with being associated with the selected blank icon 64, on the screen 60. It allows an operator to perform shortcut icon registration without moving to a screen that the operator wants to register in association with a shortcut icon, which saves operator's time and effort for the shortcut icon registration.

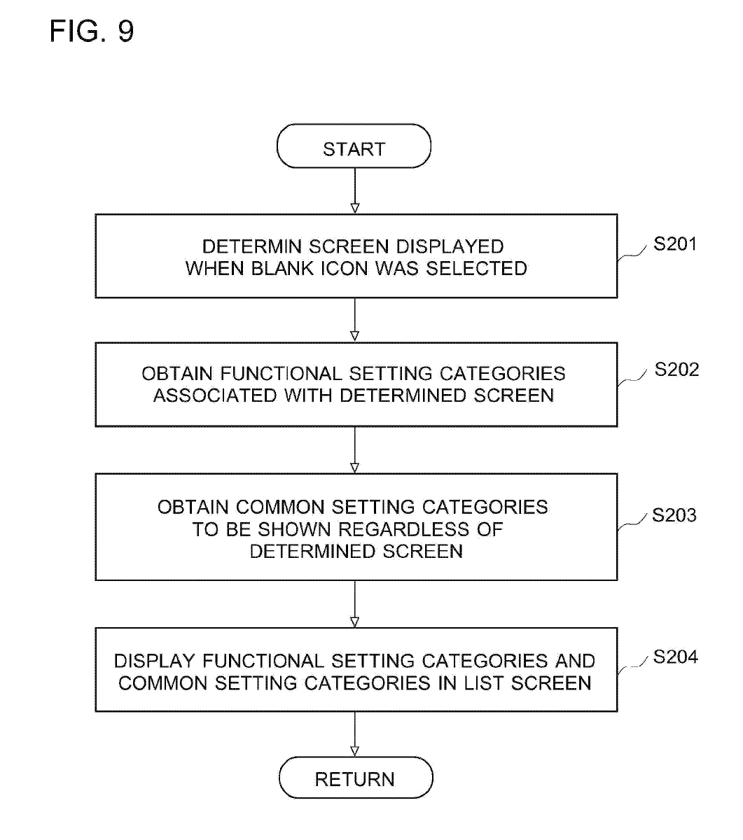

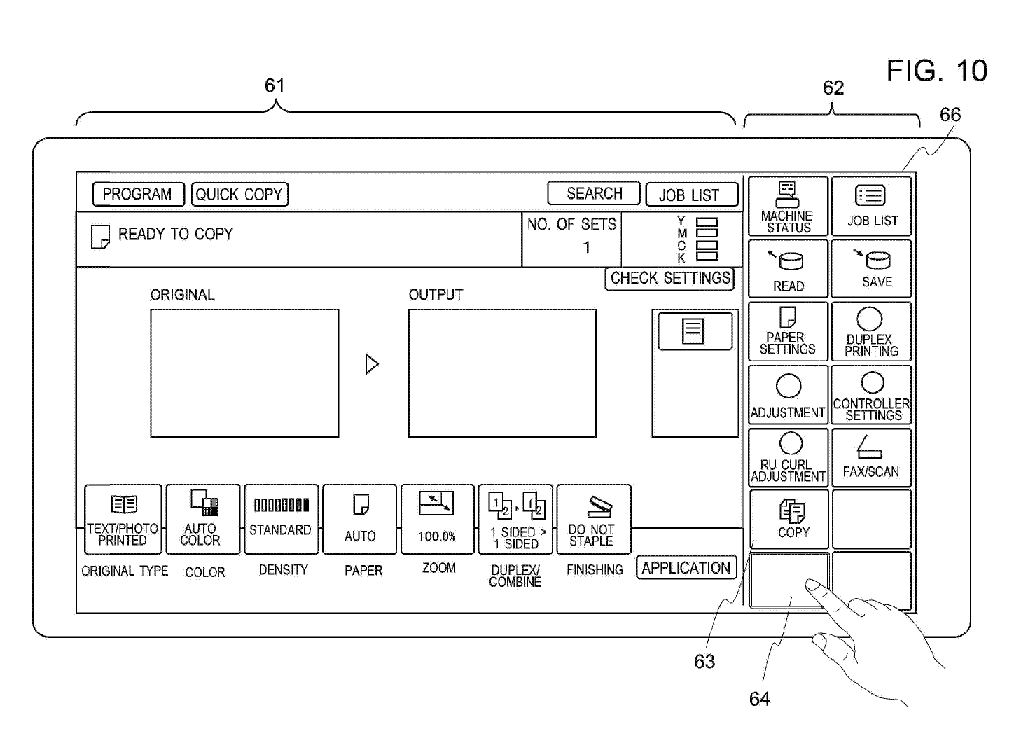

Next, a description is given of a controller, a shortcut icon registration method and a non-transitory recording medium storing a shortcut icon registration program according to one or more embodiments, with reference to FIGS. 9 to 13. FIG. 9 is a flowchart illustrating an example of operations of the image forming apparatus according to one or more embodiments. FIGS. 10 to 13 are diagrams illustrating examples of a screen displayed on the image forming apparatus according to one or more embodiments.

In previously-described embodiments, the description was given of basic operations of image forming apparatus 20 regarding the shortcut icon registration. In one or more embodiments, a description is given of operations of image forming apparatus 20 in consideration of the following fact. That is, when an operator is working with a screen for a certain kind of functions and selecting a blank icon in the icon area of the screen, there is a high probability that after a selection of the blank icon in the icon area the operator selects a setting category relating to the certain kind of functions from the list of setting categories, so as to associate the selected setting category with the selected blank icon. In consideration of the fact, image forming apparatus 20 according to one or more embodiments is configured to dynamically change setting items that appear in the list, that is, change setting categories that appears in the list flexibly in accordance with the kind of the screen displayed at the time when a blank icon was selected.

In the following operations, the basic construction of the printing system is almost the same as that shown in previously-described embodiments, but built-in controller 21 (display controller 21b) of image forming apparatus 20 changes setting categories that appear in the list in accordance with the kind of screen displayed on display and operation unit 28 at the time when a blank icon was selected. For example, on the basis of the kind of the screen displayed on display and operation unit 28 at a time when a blank icon in the icon area was selected, built-in controller 21 (display controller 21b) extracts a part of setting categories that can be registered with being associated with the blank icon, and displays, on the screen, a list of the part of the setting categories. In this process, built-in controller 21 (display controller 21b) displays, in the list of setting categories that can be registered with being associated with the blank icon, at least one setting category corresponding to the screen displayed on operation and display unit 28 at the time when the blank icon in the icon area was selected, and at least one setting category that can be registered with being associated with the blank icon, regardless of the screen displayed at the time when the blank icon was selected.

Hereinafter, a description is given of the operations of image forming apparatus 20 according to one or more embodiments, with reference to examples of screens. CPU 22 reads out the shortcut icon registration program stored in ROM 23 or storage unit 25, loads the program onto RAM 24, and executes the program, thereby executing the steps of the flowcharts illustrated in FIG. 9. Since the basic operations of image forming apparatus 20 according to one or more embodiments here are almost the same as those of previously-described embodiments, illustrated in the flowchart of FIG. 5, the description of these operations is omitted and a detailed description is given of a process of displaying a list of setting categories, corresponding to Step S102 in FIG. 5.

### Displaying a List of Setting Categories:

As illustrated in FIG. 9, built-in controller 21 (display controller 21b) determines a screen that was displayed on operation and display unit 28 at the time when a blank icon in icon area 62 was selected (Step S201). Built-in controller 21 (display controller 21b) obtains setting categories associated with the determined screen (setting categories corresponding to functions to be configured in the determined screen, which are referred to as functional setting categories) (Step S202), and further obtains setting categories to be shown in the list regardless of the screen that was displayed at the time when the blank icon was selected (in other words, setting categories that can be registered with being associated with the blank icon regardless of the determined screen, which are referred to as common setting categories) (Step S203). Built-in controller 21 (display controller 21b) then causes display and operation unit 28 to display a list screen including the functional setting categories and the common setting categories, as available options of the list of setting categories that can be registered with being associated with the blank icon, on screen 60 currently displayed on display and operation unit 28 (Step S204).

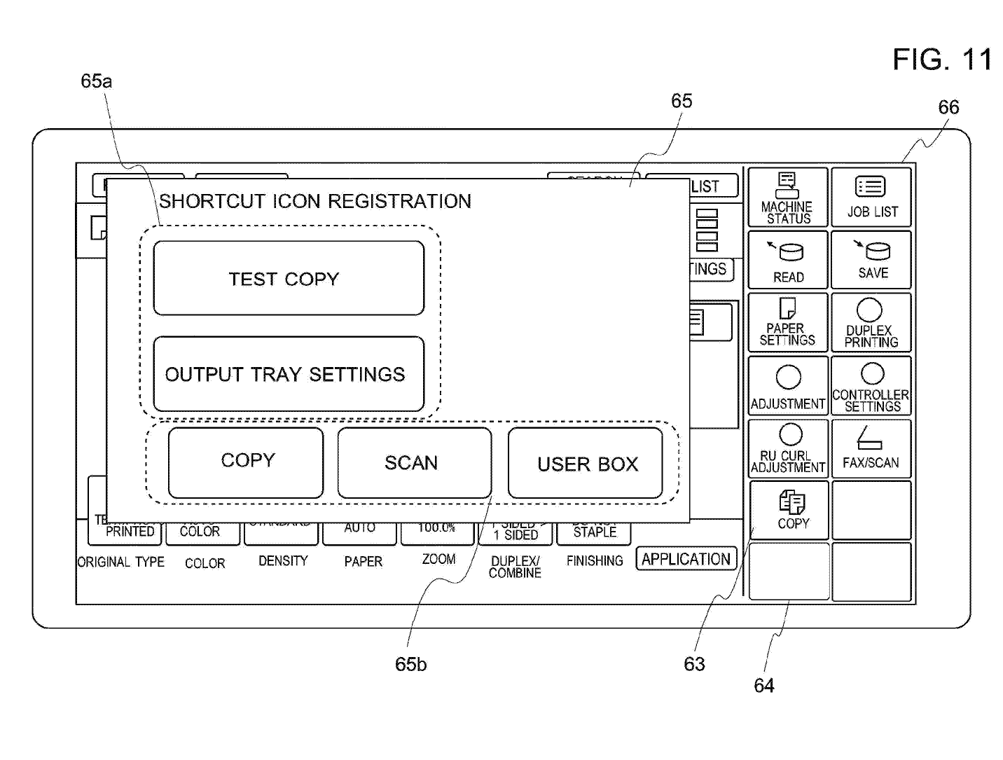

FIG. 10 illustrates an example of copy screen 66 displayed on operation and display unit 28 of image forming apparatus 20. Similarly to previously-described embodiments, copy screen 66 includes setup area 61 and icon area 62. The setup area 61 shows at least one setting item for the copy functions of image forming apparatus 20 so as to allow an operator to configure the at least one setting item on the screen. The icon area 62 shows shortcut icons so as to allow an operator to select one of the shortcut icons, where the shortcut icons include at least one blank icon 64 additionally to at least one registered shortcut icon 63. In FIG. 10, icon area 62 shows eleven registered shortcut icons 63 and three blank icons 64. In response to an operator's selection of one of blank icons 64 in the icon area 62 of the screen of FIG. 10, built-in controller 21 (display controller 21b) causes display and operation unit 28 to display list screen 65 showing a list of setting categories which can be registered with being associated with the blank icon 64, on copy screen 66 (in setup area 61 in this case), as illustrated in FIG. 11.

Displayed list screen 65 shows, as available options of the list of setting categories that can be registered with being associated with the blank icon 64, functional setting categories 65a (in FIG. 10, “TEST COPY” and “OUTPUT TRAY SETTINGS”) associated with copy screen 66 displayed at the time when blank icon 64 was selected, and common setting categories 65b (in FIG. 10, “COPY”, “SCAN” and “USER BOX”) that can be registered with being associated with the blank icon 64 regardless of the screen displayed at the time when the blank icon 64 was selected.

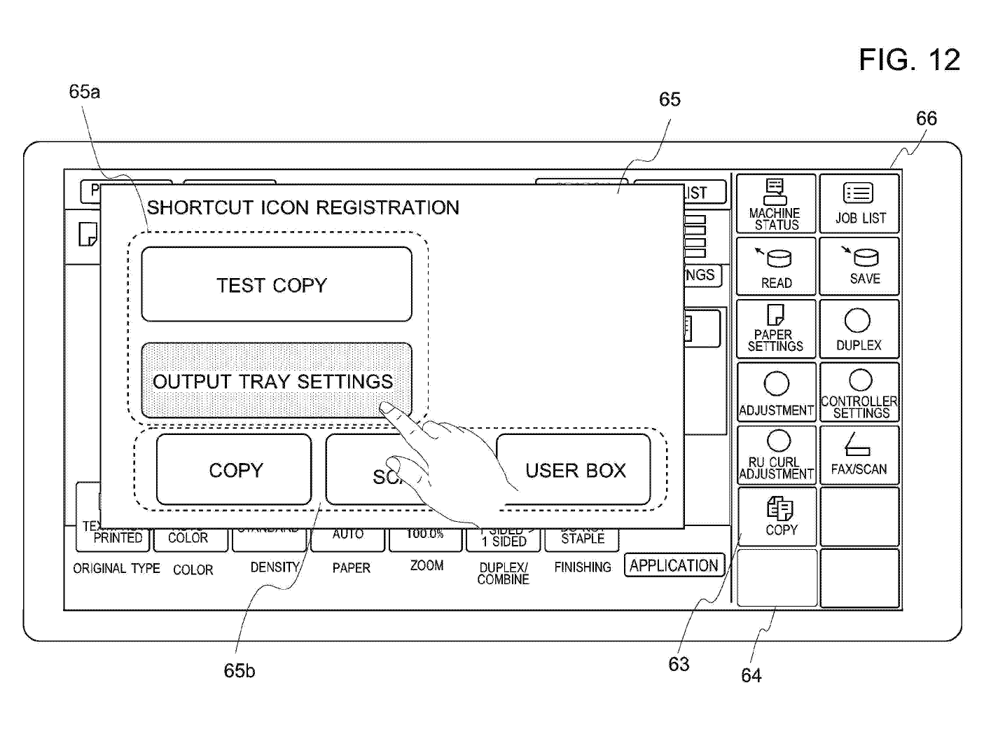

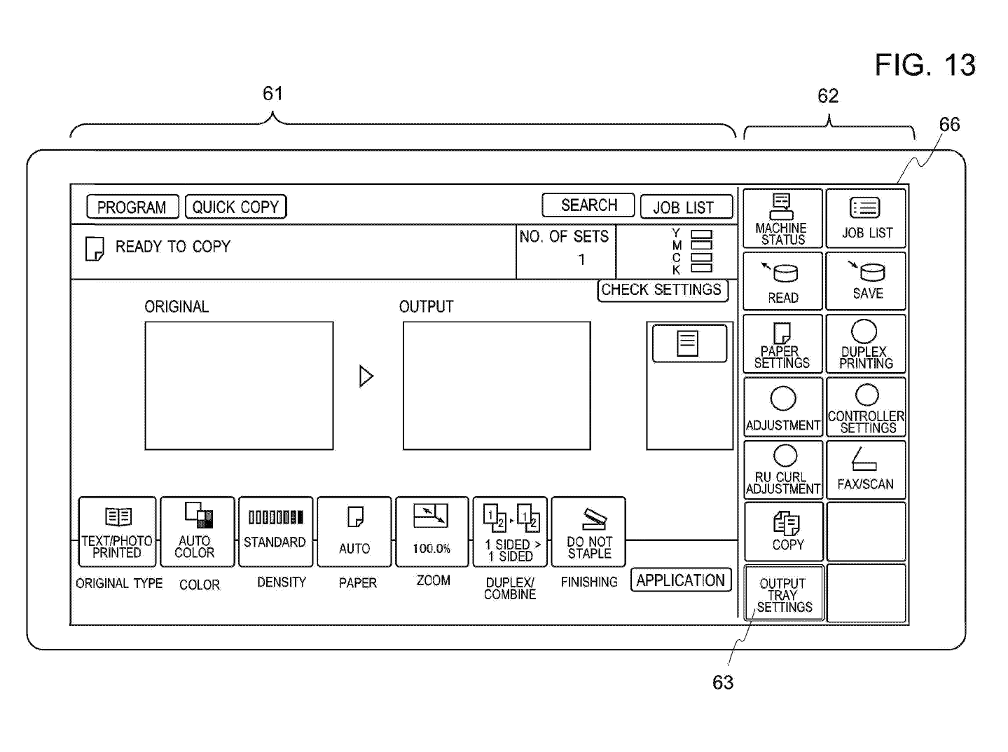

In response to operator's selection of a desired setting category (in FIG. 12, “OUTPUT TRAY SETTINGS”) from list screen 65, built-in controller 21 (display controller 21b) associates the setting category selected from list screen 65 with the selected blank icon 64. Built-in controller 21 (display controller 21b) then adds information (a text string “OUTPUT TRAY SETTINGS” in the case of FIG. 12) that indicates the setting category selected from list screen 65, to selected blank icon 64, and display them together as registered icon 63 in icon area 62, as illustrated in FIG. 13.

Accordingly, in one or more embodiments, built-in controller 21 changes setting items that appear in list screen 65 in accordance with the kind of the screen displayed on display and operation unit 28 at a time when blank icon 64 in icon area 62 was selected. It allows an operator to register a screen that handles desired setting items with being associated with a shortcut icon easily, which improves user-friendliness in the shortcut icon registration.

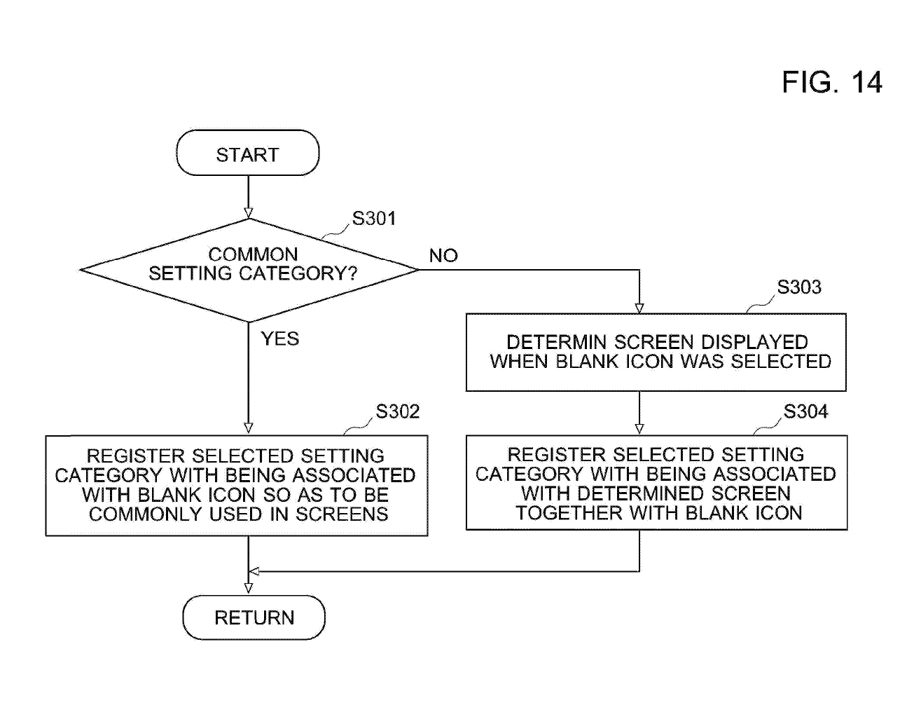

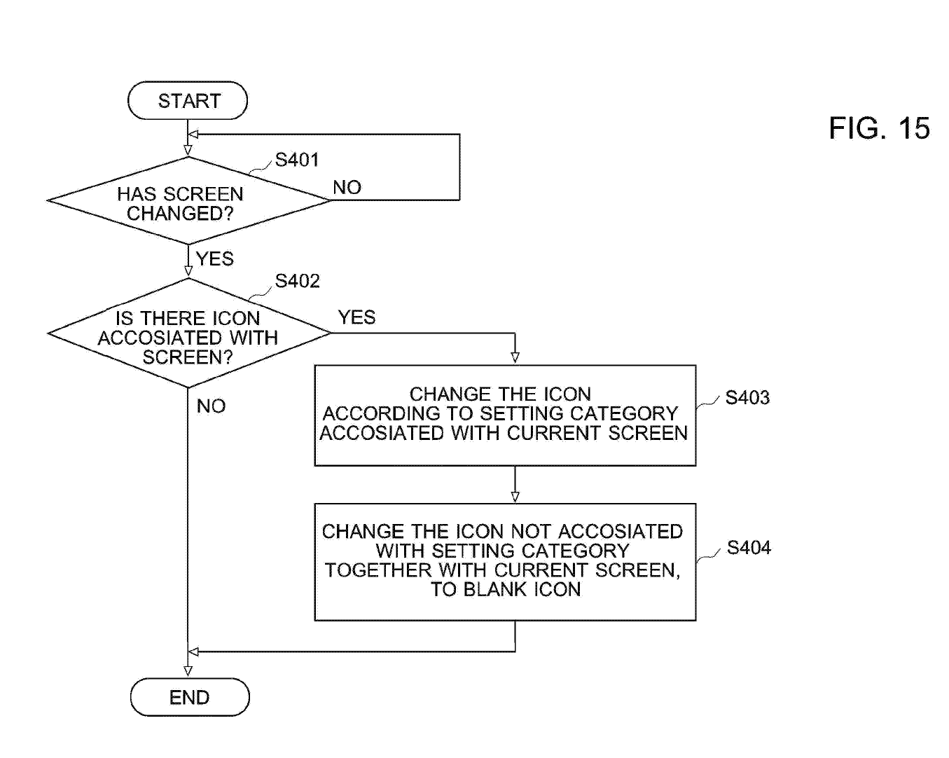

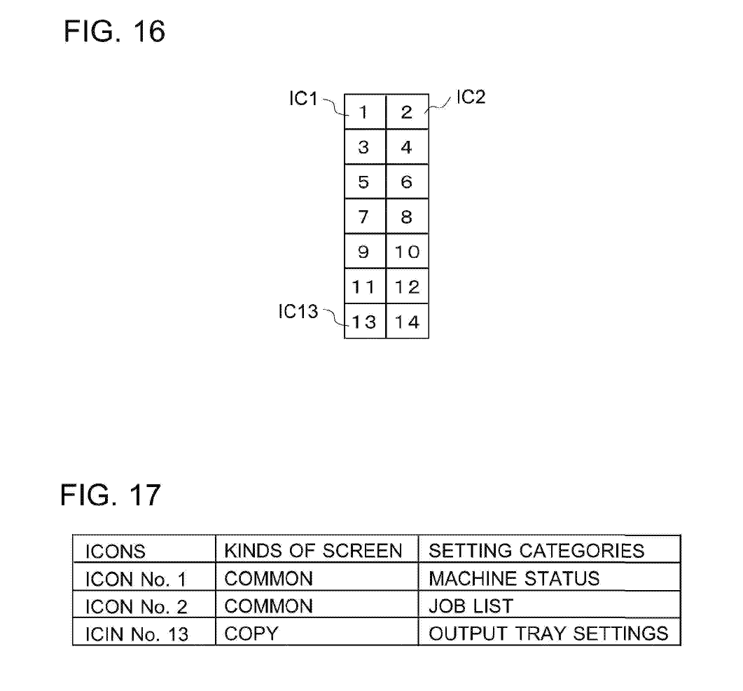

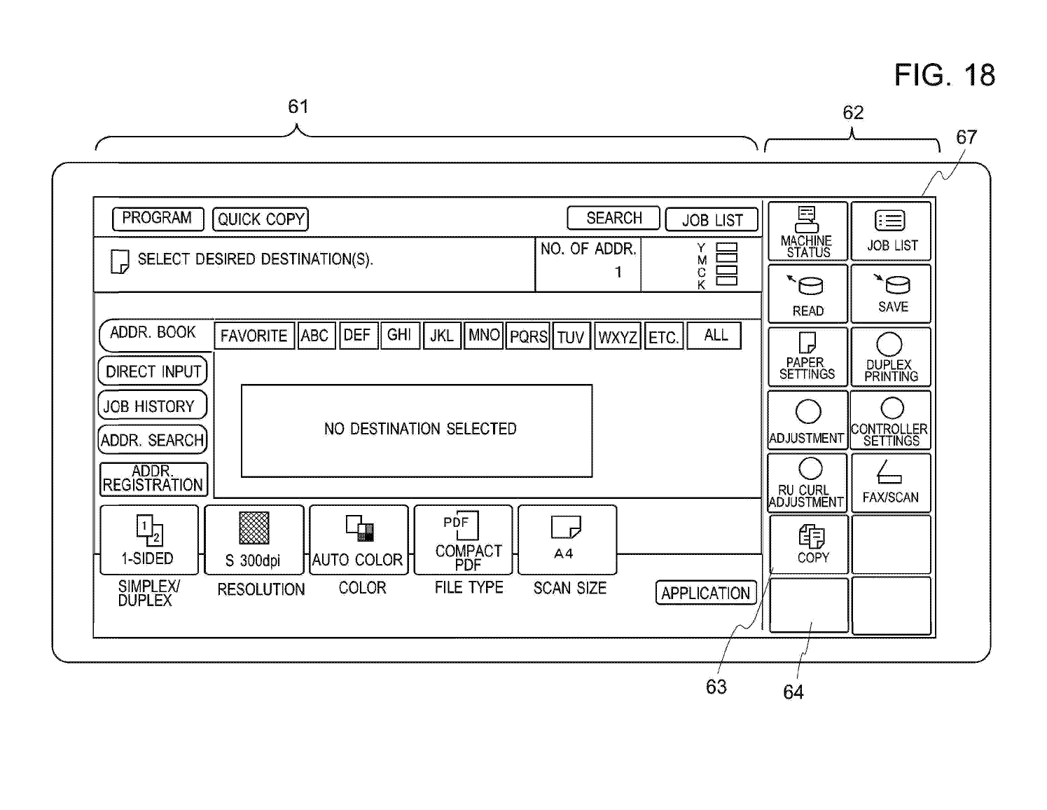

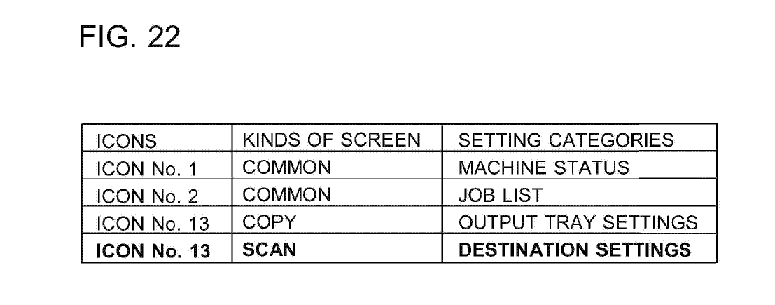

Next, a description is given of a controller, a shortcut icon registration method and a non-transitory recording medium storing a shortcut icon registration program according to one or more embodiments, with reference to FIGS. 14 to 22. Each of FIG. 14 and FIG. 15 is a flowchart illustrating an example of operations of the image forming apparatus according to one or more embodiments. FIG. 16 is a diagram illustrating an example of a layout of icons. FIG. 17 and FIG. 22 are examples of a table of icons, kinds of screen and setting categories which are associated with each other. FIGS. 18 to 21 illustrate examples of a screen displayed on the image forming apparatus according to one or more embodiments.

In previously-described embodiments with reference to FIGS. 9 to 13, the description was given of operations to, when copy screen 66 is displayed on display and operation unit 28, register the setting category of “OUTPUT TRAY SETTINGS” relating to the copy functions, with being associated with blank icon 64. There is a low probability that the setting category of “OUTPUT TRAY SETTINGS” is used in the condition that a screen other than the copy screen is displayed on display and operation unit 28, which means that a useless shortcut icon occupies a space in icon area 62. In view of that, in one or more embodiments, image forming apparatus 20 according to one or more embodiments is configured to change registered shortcut icons 63 that appear in icon area 62 in accordance with the screen (in particular, the screen corresponding to a certain kind of the functions) displayed on display and operation unit 28.

In the following operations, the basic construction of the printing system is almost the same as that shown in previously-described embodiments with reference to FIGS. 9 to 13, but when registering a setting category selected from the list screen, with being associated with a blank icon, built-in controller 21 (registration controller 21a) of image forming apparatus 20 determines a screen displayed on display and operation unit 28 at the time when the blank icon was selected, and registers the selected setting category for the blank icon, with being associated with the determined screen. In other words, built-in controller 21 (registration controller 21a) associates the kind of the screen and the selected setting category with the blank icon, and registers them into an association table.

When causing display and operation unit 28 to display a screen corresponding to a certain kind of functions after the registration process, built-in controller 21 (display controller 21b) of image forming apparatus 20 changes the shortcut icons that appear in the icon area, in accordance with the screen corresponding to the certain kind of the functions. In an example that built-in controller 21 (display controller 21b) is going to display a shortcut icon associated with a setting category for a certain kind of the functions, in the icon area of the currently displayed screen, if the currently displayed screen corresponds to the certain kind of the functions, built-in controller 21 (display controller 21b) displays a registered shortcut icon associated with the setting category, in the icon area for the shortcut icon; and if the currently displayed screen corresponds to another kind of the functions, built-in controller 21 (display controller 21b) displays an unregistered shortcut icon not associated with a setting category (a blank icon), in the icon area for the shortcut icon.

Hereinafter, a description is given of the operations of image forming apparatus 20 according to one or more embodiments, with reference to examples of screens. CPU 22 reads out the shortcut icon registration program stored in ROM 23 or storage unit 25, loads the program onto RAM 24, and executes the program, thereby executing the steps of the flowcharts illustrated in FIG. 14 and FIG. 15. Since the basic operations of image forming apparatus 20 according to one or more embodiments are almost the same as those of previously described embodiments with reference to FIGS. 1 to 8, illustrated in the flowchart of FIG. 5, the description of these operations is omitted and a detailed description is given of a process of shortcut icon registration (registering a setting category for a blank icon), corresponding to Step S104 in FIG. 5, with reference to the flowchart of FIG. 14.

### Shortcut Icon Registration:

As illustrated in FIG. 14, built-in controller 21 (registration controller 21a) judges whether the setting category selected from list screen 65 is a common setting category (Step S301). On judging that the selected setting category is a common setting category (YES in Step S301), built-in controller 21 (registration controller 21a) registers the selected setting category with being associated with the blank icon so as to be used (to be shown as an unregistered shortcut icon) commonly in various screens (Step S302). On judging that the selected setting category is not a common setting category (NO in Step S301), built-in controller 21 (registration controller 21a) determines the screen displayed on display and operation unit 28 at the time when the blank icon was selected (Step S303), and registers the selected setting category with being associated with the determined screen together with the blank icon (Step S304).

For example, in response to an operator's selection of the setting category of “OUTPUT TRAY SETTINGS” from list screen 65 in the condition that copy screen 66 is displayed on display and operation unit 28 as described in previously-described embodiments with reference to FIGS. 9 to 13, built-in controller 21 (registration controller 21a) associates the kind of the screen (copy screen 66) displayed on display and operation unit 28 at the time when the blank icon 64 was selected and the setting category selected from list screen 65 with the selected blank icon, and registers them.

FIG. 16 illustrates an example of a layout of shortcut icons shown in icon area 62, and FIG. 17 is an example of an association table, in which icons, kinds of screen and setting categories of settings items are associated with each other, given after the setting category of “OUTPUT TRAY SETTINGS” was registered with being associated with blank icon 64. In the association table, for icon No. 1 (IC1) and icon No. 2 (IC2), the setting categories of “MACHINE STATUS” and “JOB LIST” are registered, respectively, as common setting categories to be used (shown as registered shortcut icons) in icon area 62 regardless of the screen that was displayed on display and operation unit 28 at the time when the blank icon 64 was selected (in other words, that can be registered with being associated with the selected blank icon 64, regardless of the screen that was displayed on display and operation unit 28 at the time when the blank icon 64 was selected); and for icon No. 13 (IC13), the setting category of “OUTPUT TRAY SETTINGS” is registered as a functional setting category associated with copy screen 66 that was displayed on display and operation unit 28 at the time when blank icon 64 was selected.

Next, a description is given of display control of shortcut icons when a different screen is displayed after the registration of the above-described association table, with reference to the flowchart of FIG. 15.

### Display Control of Shortcut Icons:

As illustrated in FIG. 15, built-in controller 21 (display controller 21b) judges whether the current displayed screen on display and operation unit 28 has been changed to another screen, on the basis of signals output from display and operation unit 28 (Step S401). On judging that current displayed screen has been changed to another screen (YES in Step S401), built-in controller 21 (display controller 21b) checks the association table registered in the above-described step, and judges whether there is a shortcut icon associated with a screen (Step S402). On judging that there is no icon associated with a screen (NO in Step S402), built-in controller 21 (display controller 21b) ends the series of processes in the flowchart of FIG. 15.

On finding a shortcut icon associated with a screen (YES in Step S402), built-in controller 21 (display controller 21b) changes the shortcut icon that appears in icon area 62 in accordance with the setting category associated with the screen displayed after the change (the currently displayed screen) (in other words, changes the shortcut icon that appears in icon area 62 to a registered shortcut icon associated with the setting category together with the currently displayed screen) (Step S403). On finding a shortcut icon that was shown as a registered shortcut icon associated with a setting category in the screen (prior screen) displayed on display and operation unit 28 before the change (in other words, that is associated with a setting category together with the prior screen) but is not associated with a setting category together with the kind of the currently displayed screen, built-in controller 21 (display controller 21b) changes the shortcut icon shown in icon area 62 to a blank icon (Step S404).

FIG. 18 illustrates an example of scan screen 67 displayed on display and operation unit 28 after copy screen 66 on which the setting category of “OUTPUT TRAY SETTINGS” was registered to be associated with blank icon 64. Also the scan screen 67 includes setup area 61 that shows at least one setting item for scan functions so as to allow an operator to configure the at least one setting item, and icon area 62 that shows at least one registered shortcut icon 63 and at least one blank icon 64. As illustrated in FIG. 13, when copy screen 66 was displayed on display and operation unit 28, the setting category of “OUTPUT TRAY SETTINGS” was registered with being associated with icon No. 13 in the icon area 62 of copy screen (please see the position of shortcut icon IC13 in the layout of shortcut icons in icon area 62 in FIG. 16) and the “OUTPUT TRAY SETTINGS” icon appears in icon area 62. On the other hand, the “OUTPUT TRAY SETTINGS” icon shown in icon area 62 becomes useless for configuration of the scan functions, and when causing display and operation unit 28 to display scan screen 67, built-in controller 21 (display controller 21b) replaces the shortcut icon shown at the position of the icon No. 13 icon area 62 with blank icon 64 in the screen. In other words, built-in controller 21 (display controller 21b) changes shortcut icons shown in icon area 62 in accordance with the screen currently displayed on display and operation unit 28.

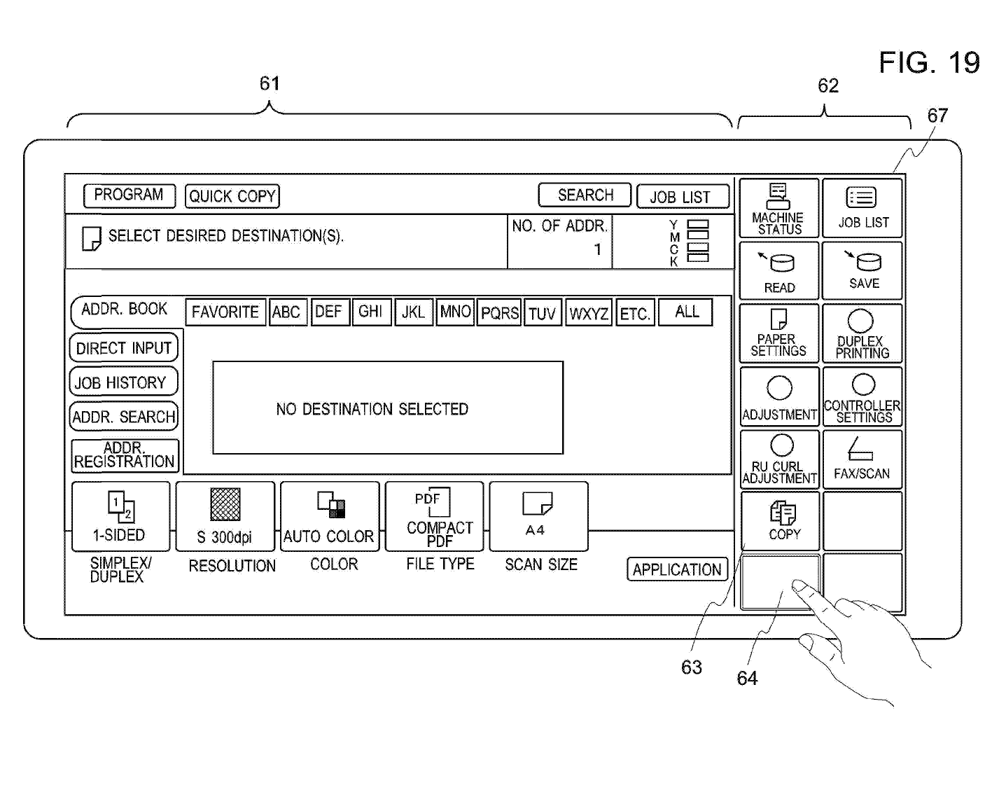

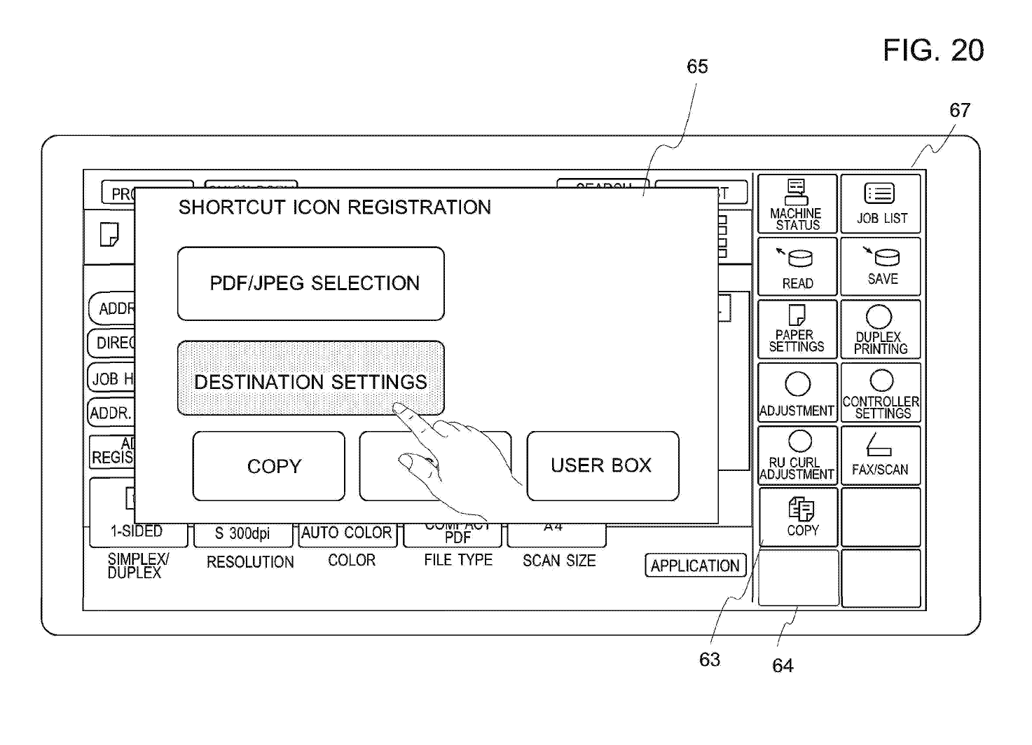

After that, in response to an operator's selection of blank icon 64 at the position of icon No. 13 in icon area 62 as illustrated in FIG. 19, built-in controller 21 (display controller 21b) causes display and operation unit 28 to display list screen 65 that shows a list of setting categories that can be registered with being associated with the selected blank icon 64, on scan screen 67 (in setup area 61 in this case), as illustrated in FIG. 20. Similarly to the previously described embodiments using copy screen 66, list screen 65 shows, as available options of the list of setting categories that can be registered the blain icon 64, at least one functional setting category (in FIG. 20, “PDF/JPEG SELECTION” and “DESTINATION SETTINGS”) associated with scan screen 67 that was displayed on display and operation unit 28 at the time when the blank icon 64 was selected, and at least one common setting category (in FIG. 20, “COPY”, “SCAN” and “USER BOX”) to be shown in list screen 65 regardless of the screen that was displayed on display and operation unit 28 at the time when the blank icon 64 was selected (in other words, that can be registered with being associated with the selected blank icon 64, regardless of the screen that was displayed on display and operation unit 28 at the time when the blank icon 64 was selected).

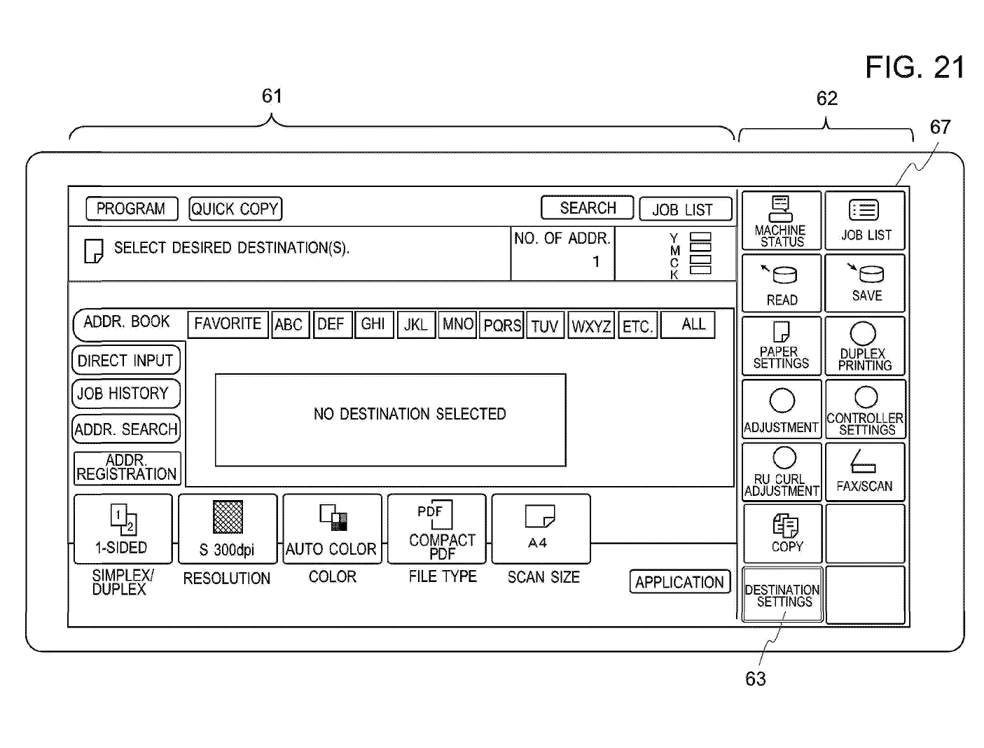

In response to operator's selection of a desired setting category (in FIG. 20, “DESTINATION SETTINGS”) from list screen 65, built-in controller 21 (display controller 21b) associates the screen (scan screen 67) that was displayed on display and operation unit 28 at the time when the blank icon 64 was selected, and the setting category (“DESTINATION SETTINGS”) selected from list screen 65, with the selected blank icon 64, to register them. Built-in controller 21 (display controller 21b) then adds information (a text string “DESTINATION SETTINGS” in the case of FIG. 21) that indicates the setting category selected from list screen 65, to selected blank icon 64, and display them together as registered icon 63 in icon area 62, as illustrated in FIG. 21. Similarly to the association table illustrated in FIG. 17, in the association table illustrated in FIG. 22, for icon No. 1 and icon No. 2, the setting categories of “MACHINE STATUS” and “JOB LIST” are registered, respectively, as common setting categories to be used (shown as registered shortcut icons) in icon area 62 regardless of the screen that was displayed on display and operation unit 28 at the time when the blank icon 64 was selected (in other words, that can be registered with being associated with the selected blank icon 64, regardless of the screen that was displayed on display and operation unit 28 at the time when the blank icon 64 was selected); and for icon No. 13 (IC13), the setting category of “OUTPUT TRAY SETTINGS” is registered as a functional setting category associated with copy screen 66 and the setting category of “DESTINATION SETTINGS” is registered as a functional setting category associated with scan screen 77. That is, shortcut icons that appear at the same position in the icon area 62 of different screens can be associated with different setting categories. When causing display and operation unit 28 to a screen, built-in controller 21 (display controller 21b) changes shortcut icons shown in icon area 62 of the screen, in accordance with the contents of the association table.

Accordingly, in one or more embodiments, when displaying, on display and operation unit 28, a screen corresponding to a certain kind of the functions, built-in controller 21 changes shortcut icons shown in icon area 62 in accordance with the screen corresponding to the certain kind of the functions. For example, built-in controller 21 replaces a registered shortcut icon 63 with blank icon 64 with a change of the screen displayed on display and operation unit 28 or changes the appearance of a registered shortcut icon with a change of the screen displayed on display and operation unit 28. It allows an operator to select one of shortcut icons appropriately prepared in accordance with the currently displayed screen, which improves user-friendliness.

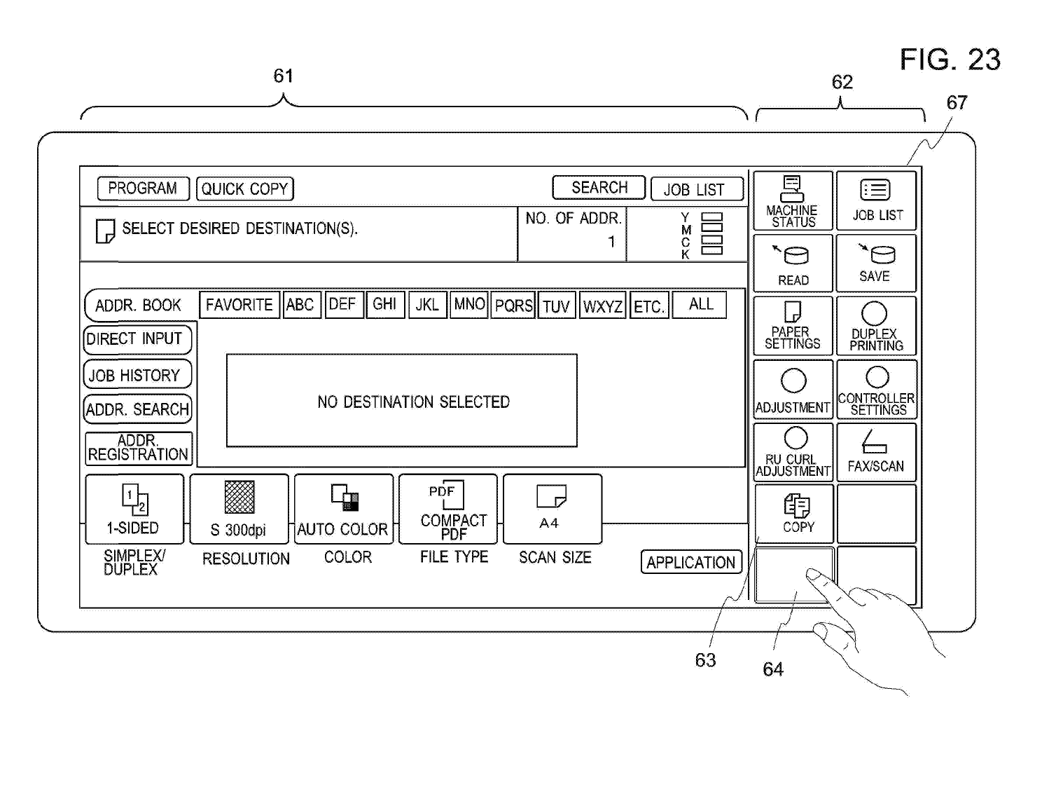

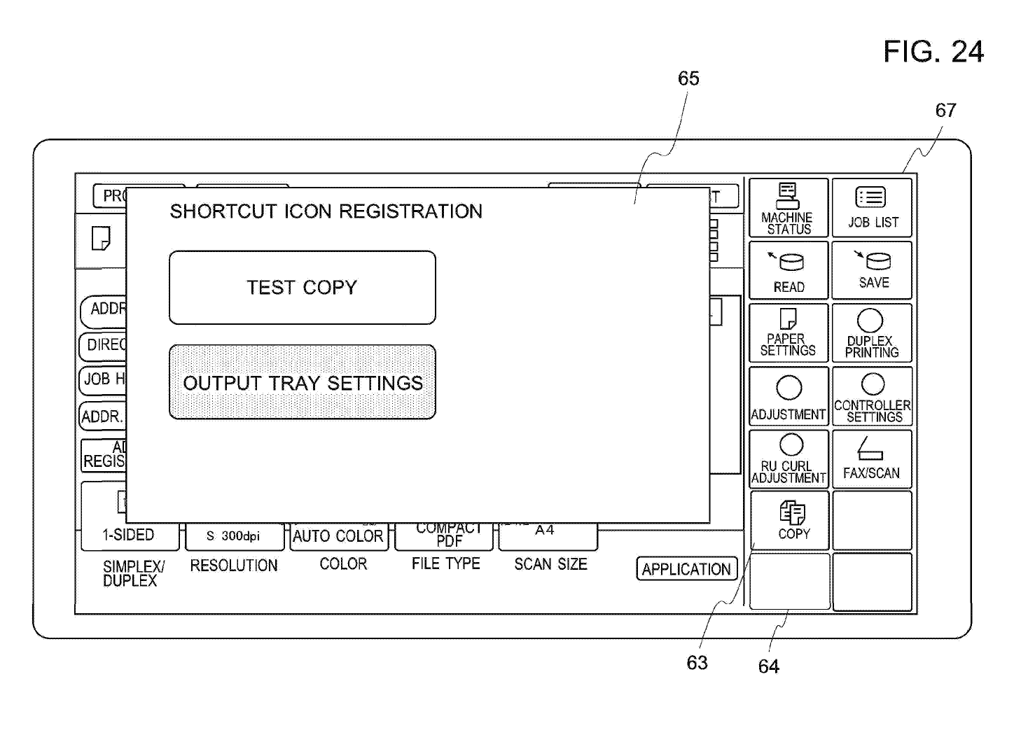

Next, a description is given of a controller, a shortcut icon registration method and a non-transitory recording medium storing a shortcut icon registration program according to one or more embodiments, with reference to FIG. 23 and FIG. 24. FIG. 23 and FIG. 24 illustrate examples of a screen displayed on the image forming apparatus according to one or more embodiments.

In previously-described embodiments with reference to FIGS. 9 to 13, the description was given of operations to cause display and operation unit 28 to display in list screen 65, as available options of the list of setting categories that can be registered with being associated with blank icon 64, setting categories associated with the screen that was displayed on display and operation unit 28 at the time when the blank icon 64 was selected. There is a high probability that, when registering a setting category with being associated with a certain blank icon 64, an operator selects a setting category which relates to a setting category registered for registered shortcut icon 63 located close to the certain blank icon 64 in icon area 62 of the currently displayed screen, to register the selected setting category with being associated with the certain blank icon 64, in view of usability and operability of the shortcut icons in icon area 62. In view of that, in one or more embodiments, image forming apparatus 20 according to one or more embodiments is configured to, in response to an operator's selection of blank icon 64 in icon area 62, display, in the list, the categories of setting items that relate to a category of setting items associated with another registered shortcut icon 63 placed close to the selected blank icon 64 in the icon area 62.

In the following operations, the basic construction of the printing system is almost the same as that shown in previously-described embodiments with reference to FIGS. 1 to 8, but when displaying on display and operation unit 28 a list of setting categories that can be registered with being associated with a selected blank icon, built-in controller 21 (display controller 21b) of image forming apparatus 20 causes display and operation unit 28 to display a list of setting categories that can be registered with being associated with the blank icon 64, while putting priority on setting categories relating to at least one setting category registered with being associated with at least one registered shortcut icon 63 placed close to the selected blank icon 64 in icon area 62 (for example, at least one shortcut icon selected from registered shortcut icons 63 that are orthogonally-adjacent to the selected blank icon 64 or registered shortcut icons 63 that are orthogonally or diagonally-adjacent to the selected blank icon 64).

Hereinafter, a description is given of operations of the shortcut icon registration, with reference to examples of screens.

FIG. 23 illustrates an example of scan screen 67 displayed on operation and display unit 28 of image forming apparatus 20. In response to an operator's selection of one of blank icons 64 in icon area 62 of scan screen 67, built-in controller 21 (display controller 21b) causes display and operation unit 28 to display list screen 65 showing a list of setting categories which can be registered with being associated with blank icon 64, on scan screen 67 (in setup area 61 in this case) currently displayed on display and operation unit 28, as illustrated in FIG. 24.

In previously-described embodiments with reference to FIGS. 9 to 22, the list screen 65 shows, as available options of the list of setting categories that can be registered with being associated with blank icon 64, functional setting categories (“PDF/JPEG SELECTION” and “DESTINATION SETTINGS”) associated with scan screen 67 that was displayed on display and operation unit 28 at the time when blank icon 64 was selected, and common setting categories (“COPY”, “SCAN” and “USER BOX”) to be shown regardless of the screen that was displayed on display and operation unit 28 at the time when blank icon 64 was selected. In one or more embodiments, the list screen 65 shows, as available options of the list of setting categories that can be registered with being associated with blank icon 64, functional setting categories of “TEST COPY” and “OUTPUT TRAY SETTINGS” that relate to the copy functions, because there is a “COPY” icon as registered shortcut icon 63 close to the selected blank icon 64.

Accordingly, in one or more embodiments, built-in controller 21 displays in list screen 65, as available options of the list of setting categories that can be registered with being associated with blank icon 64, setting categories that relate to a setting category registered with being associated with registered shortcut icon 63 placed close to the selected blank icon 64 in the icon area 62. It allows an operator to associate a desired setting category with a shortcut icon quickly and improves user-friendliness.

It should be noted that the present invention should not be limited to the above-described examples, and the constitution and control of the system and each device can be modified suitably, unless the modification deviates from the intention of the present invention.

For example, the previously-described embodiments disclosed the shortcut icon registration operations of image forming apparatuses 20, but the described operations and methods of shortcut icon registration are applicable to shortcut icon registration to be performed on a print instruction screen of printer driver 11c executed in client terminal 10 and a setup screen displayed on controller 50.

For another example, the previously-described embodiments showed the operations to register a category of setting items for a certain kind of functions of image formation including printing, with being associated with a shortcut icon. Alternatively, the described operations and methods of shortcut icon registration are applicable to functions that can be configured by operator's operations, on an apparatus configured to display various screens that handles setup items for the functions, to allow an operator to move to at least one of screen and configure setting items for the functions thereon.

One or more embodiments of the present invention are applicable to controllers configured to display screens, each of which handles at least one setting item for a certain kind of functions, so as to allow an operator to move to one of the screens and configure at least one setting item for the certain kind of functions on the screens, shortcut icon registration methods for registering a shortcut icon being an icon for instructing to display a screen which handles at least one setting item for a certain kind of function, and non-transitory recording media each storing a computer-readable shortcut icon registration program for controlling registration of shortcut icons.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A controller comprising:
a display that displays a plurality of screens, each of which handles at least one setting item for one of a plural kinds of functions; and
a hardware processor that:
displays, on the display, one of the plurality of screens including:
a setup area showing at least one setting item in a category for one of the plural kinds of functions; and
an icon area showing shortcut icons for instructing the display to display one of the plurality of screens, wherein the shortcut icons include at least one registered shortcut icon associated with a category of setting items for one of the plural kinds of functions and at least one unregistered shortcut icon not associated with a category of setting items for one of the plural kinds of functions;
in response to an operator's selection of an unregistered shortcut icon in the icon area, displays, on the one of the plurality of screens being displayed, a list of categories of setting items that can be registered as being associated with the unregistered shortcut icon;
in response to an operator's selection of one of the categories of setting items from the list, registers the one of the categories of setting items as being associated with the unregistered shortcut icon; and
displays, in the icon area, information that indicates the one of the categories of setting items, together with the unregistered shortcut icon.

2. The controller of claim 1, wherein the displaying the list by the hardware processor includes changing the one of the categories of setting items that appear in the list, in accordance with a specific screen being one of the plurality of screens displayed on the display at a time when the operator selects the unregistered shortcut icon in the icon area.

3. The controller of claim 2, wherein the displaying of the list by the hardware processor further includes:
extracting a part of the categories of setting items that is registered as being associated with the unregistered shortcut icon, based on the specific screen, and
displaying a list of the part of the categories of setting items.

4. The controller of claim 2, wherein the displaying of the list by the hardware processor further includes displaying a list of at least one category of setting items that corresponds to the specific screen and can be registered as being associated with the unregistered shortcut icon, and at least one category of setting items that can be registered as being associated with the unregistered shortcut icon, regardless of the specific screen.

5. The controller of claim 1, wherein:
the registering by the hardware processor includes registering the one of the categories of setting items and a specific screen being one of the plurality of screens displayed on the display at a time when the operator selects the unregistered shortcut icon in the icon area, as being associated with the unregistered shortcut icon;
the hardware processor further displays, on the display, one of the plurality of screens corresponding to a certain kind of the functions, after the registering, the one of the plurality of screens including the setup area and the icon area, and
the additional displaying one of the plurality of screens includes changing the shortcut icons that appear in the icon area, in accordance with the one of the plurality of screens corresponding to the certain kind of the functions.

6. The controller of claim 5, wherein the additional displaying the one of the plurality of screens includes:
on displaying a shortcut icon associated with an additional category of setting items for the certain kind of the functions, in the icon area of one of the plurality of screens corresponding to the certain kind of the functions, displaying a registered shortcut icon associated with the additional category of setting items, in the icon area for the shortcut icon; and
on displaying the shortcut icon in the icon area of one of the plurality of screens corresponding to another kind of the functions, displaying an unregistered shortcut icon not associated with any category of setting items, in the icon area for the shortcut icon.

7. The controller of claim 1, wherein the displaying the list includes displaying, in the list, the categories of setting items that relate to a category of setting items associated with another registered shortcut icon placed close to the unregistered shortcut icon in the icon area.

8. A method of registering a shortcut icon in an apparatus to display, on a display of the apparatus, a plurality of screens, each of which handles at least one setting item for one of a plural kinds of functions, wherein the shortcut icon is an icon for instructing the display to display one of the plurality of screens, the method comprising:
displaying, on the display, one of the plurality of screens including:
a setup area showing at least one setting item in a category for one of the plural kinds of functions; and
an icon area showing shortcut icons for instructing the display to display one of the plurality of screens, wherein the shortcut icons include at least one registered shortcut icon associated with a category of setting items for one of the plural kinds of functions and at least one unregistered shortcut icon not associated with a category of setting items for one of the plural kinds of functions;
in response to an operator's selection of an unregistered shortcut icon in the icon area, displaying, on the one of the plurality of screens being displayed, a list of categories of setting items that can be registered as being associated with the unregistered shortcut icon;
in response to an operator's selection of one of the categories of setting items from the list, registering the one of the categories of setting items as being associated with the unregistered shortcut icon; and
displaying, in the icon area, information that indicates the one of the categories of setting items, together with the unregistered shortcut icon.

9. The method of claim 8, wherein the displaying of the list includes changing the one of the categories of setting items that appear in the list, in accordance with a specific screen being one of the plurality of screens displayed on the display at a time when the operator selects the unregistered shortcut icon in the icon area.

10. The method of claim 9, wherein the displaying of the list further includes:
extracting a part of the categories of setting items that is registered as being associated with the unregistered shortcut icon, based on the specific screen; and
displaying a list of the part of the categories of setting items.

11. The method of claim 9, wherein the displaying of the list further includes displaying a list of at least one category of setting items that corresponds to the specific screen and can be registered as being associated with the unregistered shortcut icon, and at least one category of setting items that can be registered as being associated with the unregistered shortcut icon, regardless of the specific screen.

12. The method of claim 8, wherein:
the registering includes registering the one of the categories of setting items and a specific screen being one of the plurality of screens displayed on the display at a time when the operator selects the unregistered shortcut icon in the icon area, as being associated with the unregistered shortcut icon;
the method further comprises additional displaying, on the display, one of the plurality of screens corresponding to a certain kind of the functions, after the registering, the one of the plurality of screens including the setup area and the icon area; and
the additional displaying includes changing the shortcut icons that appear in the icon area, in accordance with the one of the plurality of screens corresponding to the certain kind of the functions.

13. The method of claim 12, wherein the additional displaying the one of the plurality of screens includes:
on displaying a shortcut icon associated with an additional category of setting items for the certain kind of the functions, in the icon area of one of the plurality of screens corresponding to the certain kind of the functions, displaying a registered shortcut icon associated with the additional category of setting items, in the icon area for the shortcut icon; and
on displaying the shortcut icon in the icon area of one of the plurality of screens corresponding to another kind of the functions, displaying an unregistered shortcut icon not associated with any category of setting items, in the icon area for the shortcut icon.

14. The method of claim 8, wherein the displaying the list includes displaying, in the list, the categories of setting items that relate to a category of setting items associated with another registered shortcut icon placed close to the unregistered shortcut icon in the icon area.

15. A non-transitory recording medium storing a computer-readable program for registering a shortcut icon in an apparatus to display, on a display of the apparatus, a plurality of screens, each of which handles at least one setting item for one of a plural kinds of functions, wherein the shortcut icon is an icon for instructing the display to display one of the plurality of screens, the program comprising instructions which, when executed by a hardware processor of the apparatus, cause the hardware processor to:
display, on the display, one of the plurality of screens including:
a setup area showing at least one setting item in a category for one of the plural kinds of functions; and
an icon area showing shortcut icons for instructing the display to display one of the plurality of screens, wherein the shortcut icons include at least one registered shortcut icon associated with a category of setting items for one of the plural kinds of functions and at least one unregistered shortcut icon not associated with a category of setting items for one of the plural kinds of functions;
in response to an operator's selection of an unregistered shortcut icon in the icon area, display, on the one of the plurality of screens being displayed, a list of categories of setting items that can be registered as being associated with the unregistered shortcut icon;
in response to an operator's selection of one of the categories of setting items from the list, register the one of the categories of setting items as being associated with the unregistered shortcut icon; and
display, in the icon area, information that indicates the one of the categories of setting items, together with the unregistered shortcut icon.

16. The non-transitory recording medium of claim 15, wherein the displaying the list by the hardware processor includes changing the one of the categories of setting items that appear in the list, in accordance with a specific screen being one of the plurality of screens displayed on the display at a time when the operator selects the unregistered shortcut icon in the icon area.

17. The non-transitory recording medium of claim 16, wherein the displaying of the list by the hardware processor further includes:
extracting a part of the categories of setting items that is registered as being associated with the unregistered shortcut icon, based on the specific screen; and
displaying a list of the part of the categories of setting items.

18. The non-transitory recording medium of claim 16, wherein the displaying of the list by the hardware processor further includes displaying a list of at least one category of setting items that corresponds to the specific screen and can be registered as being associated with the unregistered shortcut icon, and at least one category of setting items that can be registered as being associated with the unregistered shortcut icon, regardless of the specific screen.

19. The non-transitory recording medium of claim 15, wherein:
the registering by the hardware processor includes registering the one of the categories of setting items and a specific screen being one of the plurality of screens displayed on the display at a time when the operator selects the unregistered shortcut icon in the icon area, as being associated with the unregistered shortcut icon;
the hardware processor further displays, on the display, one of the plurality of screens corresponding to a certain kind of the functions, after the registering, the one of the plurality of screens including the setup area and the icon area; and
the additional displaying one of the plurality of screens includes changing the shortcut icons that appear in the icon area, in accordance with the one of the plurality of screens corresponding to the certain kind of the functions.

20. The non-transitory recording medium of claim 19, wherein the additional displaying the one of the plurality of screens includes:
on displaying a shortcut icon associated with an additional category of setting items for the certain kind of the functions, in the icon area of one of the plurality of screens corresponding to the certain kind of the functions, displaying a registered shortcut icon associated with the additional category of setting items, in the icon area for the shortcut icon; and
on displaying the shortcut icon in the icon area of one of the plurality of screens corresponding to another kind of the functions, displaying an unregistered shortcut icon not associated with any category of setting items, in the icon area for the shortcut icon.

21. The non-transitory recording medium of claim 15, wherein the displaying the list includes displaying, in the list, the categories of setting items that relate to a category of setting items associated with another registered shortcut icon placed close to the unregistered shortcut icon in the icon area.
